(19) United States
(12) Patent Application Publication
(10) Pub. No.: US 2019/0373419 A1
(43) Pub. Date: Dec. 5, 2019

(54) VOICE COMMUNICATIONS FOR PLATOONING VEHICLES

(71) Applicant: Peloton Technology, Inc., Mountain View, CA (US)

(72) Inventors: Oliver BAYLEY, Pacifica, CA (US); Jamal BENBRAHIM, San Jose, CA (US); Sasha KOZARUK, Redwood City, CA (US)

(21) Appl. No.: 16/424,958

(22) Filed: May 29, 2019

Related U.S. Application Data
(60) Provisional application No. 62/678,056, filed on May 30, 2018.

(51) Int. Cl. H04W 4/10; G08G 1/00; H04W 4/46; H04W 76/14; H04W 76/45

(52) U.S. Cl. CPC H04W 4/10; G08G 1/22; H04W 76/45; H04W 76/14; H04W 4/46

(57) ABSTRACT

Systems and methods for maintaining voice communications between platooning vehicles, vehicles and other non-platooning vehicles, and with a Network Operations Controller (NOC) is disclosed. In various embodiments, the voice communications are maintained over a direct vehicle-to-vehicle link and/or a cellular link either between vehicles or with the NOC. Also disclosed is a PTT protocol with an interrupt feature that allows a first driver to interrupt a second driver while the second driver is transmitting. Also disclosed is using the system and methods for maintaining voice communications among drivers of tractor-trailer trucks operating in a platoon.

### CROSS-REFERENCE TO RELATED APPLICATIONS

This application claims priority of U.S. Provisional Patent Application Ser. No. 62/678,056 filed May 30, 2018, which is incorporated by reference herein for all purposes.

### BACKGROUND

The present application relates generally to voice communications between platooning vehicles.

Radios have conventionally been used for voice communications between vehicles and/or between vehicles and a central operations center, such as a dispatcher.

One type of radio, commonly known as Citizens Band or “CB” radios, is a short-distance communication system that allows individuals to communicate over a number of predetermined channels. CB radios have a number of drawbacks. With CB radios, only one radio can transmit over a given channel at a time. Others listening to the same channel need to wait for the shared channel to become available before they can transmit. CB radios are also short-range. If two parties in vehicles are out of range, they are unable to communicate using CB radios. In addition, CB radios rely on a broadcast model. When a sender broadcasts over a given channel, the sender has no idea who may be listening, or if the intended recipient(s) received the transmission or not. Many drivers, particularly in the trucking industry, have used CB radios to communicate with one another.

Police and fire departments, first responders, taxi cab companies and fleet managers have typically relied on two-way radios for voice communications between both vehicles and a central dispatcher and between vehicles. A two-way radio is a transceiver that can both transmit and receive transmissions. An operator can have a conversation with other similar radios operating on the same frequency channel. Two way radios typically operate in a half-duplex mode. That is, an operator can talk, or can listen, but not at the same time. A Push To Talk or PTT button is provided to activate a transmitter. When released, the receiver is active. Full-duplex communication can be achieved by using two different channels simultaneously, meaning one channel is used for receiving transmissions, while the other is used for outgoing transmissions.

With the wide spread popularity of mobile phones and other smart mobile communication devices, such as tablet computers, drivers can now communicate with both other drivers and non-drivers via cellular telephone calls. In addition, voice communication applications or “apps”, such as Voxer by Voxer, Inc. located in San Francisco Zello by Zello, located in Austin Tex., enable drivers to communicate with other drivers using their smart phones similar to a PTT radio device. The use of cell phones by drivers has a number of drawbacks. As is well document, using a cell phone is a major distraction for drivers, resulting in a significantly higher degree of traffic accidents and fatalities.

In recent years significant strides have been made in the field of automated vehicle control. One segment of vehicle automation relates to connected vehicle control such as vehicular convoying systems that enable vehicles to follow closely together in a safe, efficient and convenient manner Following closely behind another vehicle has the potential for significant fuel savings, but is generally unsafe when done manually by the driver. One type of vehicle convoying system is sometimes referred to as vehicle platooning in which a second, and potentially additional, vehicle(s) is/are automatically or semi-automatically controlled to closely follow a lead vehicle in a safe manner.

The fuel efficiency advantages of platooning are particularly noticeable in fields such as the trucking industry in which long distances tend to be traveled at highway speeds. One of the on-going challenges of vehicle platooning and convoying systems is creating controller systems architectures that are cost effective, efficient and meet the stringent safety standards required for integration into mainstream road vehicles. Although existing gap control system architectures work well, there are continuing efforts to develop improved platoon controllers that provide safe and fuel efficient operation while delivering a comfortable user experience.

With platooning vehicles, there is often a need for drivers to be in direct voice communications with one another. In addition, drivers of platooning vehicles often have a need to communicate with other non-platooning drivers and well as a central dispatch location. Improved systems and method for voice communications for drivers of platooning vehicles is therefore needed.

### SUMMARY

Systems and methods for maintaining voice communications between platooning vehicles, vehicles and other non-platooning vehicles, and with a Network Operations Controller (NOC) are disclosed. In various embodiments, the voice communications are maintained over a direct vehicle-to-vehicle link and/or a network link either between vehicles or with the NOC. Also disclosed is a PTT protocol with an interrupt feature that allows a first driver to interrupt a second driver while the second driver is transmitting.

In one non-exclusive embodiment, voice communications are conducted over the same data link used to transfer control data for maintaining a platoon between two (or more) vehicles. By “piggybacking” voice communications over an already existing data link, direct, vehicle-to-vehicle, voice communications can be established between the vehicles.

In another non-exclusive embodiment, a method is disclosed for coordinating a platoon among vehicles. In an initial step, a NOC identifies two (or more) vehicles as good candidates for platooning. Once identified, the NOC establishes voice communications with the drivers of the candidate vehicles over a communication link, such as but not limited to a cellular network, a satellite network, a local area network, a WiFi network, the Internet, or any combination thereof. Thereafter, the drivers can coordinate their rendezvous using either the voice communication link via the NOC or by establishing another voice link between the drivers via a network. Upon rendezvous, yet another direct, vehicle-to-vehicle, link may be established. Thereafter, any of the links may be redundantly maintained and used for voice communications.

In yet another non-exclusive embodiment, a Push-To-Talk protocol, with an interrupt feature, may be used for voice communication among drivers of vehicles. Unlike conventional PTT, the PTT protocol as described herein allows one driver to interrupt the voice transmissions of a second driver. The PTT with interrupt is thus similar to conventional full-duplex communication in the sense that it allows one party to talk over the other, however, it eliminates the problems of feedback and echo caused by two open microphones and speakers in the cabin of the communicating vehicles.

In yet another non-exclusive embodiment, a method is disclosed for organizing and coordinating a platoon of vehicles using different voice communication links, including between (a) a NOC and the vehicles over a network connection, (b) between the vehicles using another network connection, and (c) over a direct communication link established between the vehicles once the platoon has been established.

### BRIEF DESCRIPTION OF THE DRAWINGS

The invention and the advantages thereof, may best be understood by reference to the following description taken in conjunction with the accompanying drawings in which:

FIG. 1 is a block diagram of a controller architecture suitable for use in an automated or partially automated vehicle control system that supports platooning.

FIG. 2 is a block diagram of a representative platoon controller architecture suitable for use in the automated or partially automated vehicle control system of FIG. 1.

FIG. 3 is a block diagram of a gap controller in accordance with one embodiment.

FIGS. 4A-4C are a series of diagrams illustrating different control states used by a gap regulator in accordance with one embodiment during different operational states.

FIG. 5 is a state space diagram illustrating a sliding mode control scheme.

FIG. 6 is a specific ASIL compliant controller hardware architecture suitable for use in an automated or partially automated vehicle control system that supports platooning.

FIG. 7 illustrates components of a gateway in accordance with one embodiment.

FIG. 8 Illustrates a block diagram of a gateway and associated components for implementing voice communications for platooning vehicles in accordance with a non-exclusive embodiment of the invention.

FIG. 9 illustrates various links for voice communication among platooning vehicles in accordance with a non-exclusive embodiment of the invention.

FIG. 10 illustrates is a flowchart for establishing various types of voice communication links for platooning vehicles in accordance with a non-exclusive embodiment of the invention.

FIG. 11 is a flowchart illustrating a hand-over of voice communications between different links in accordance with a non-exclusive embodiment of the invention.

FIG. 12A and FIG. 12B illustrate two different network topologies for platooning vehicles in accordance with different embodiments of the invention.

FIGS. 13-15 illustrate flow diagrams illustrating various PTT protocols for platooning vehicles in accordance with non-exclusive embodiments of the invention.

FIG. 16 illustrates a flow chart for handling interrupts of voice communications between platooning vehicles in response to a communication from the NOC in accordance with a non-exclusive embodiment of the invention.

FIG. 17 illustrates a flow chart for handing interrupts caused by trigger events in accordance with various non-exclusive embodiments of the invention.

FIG. 18 illustrates another flow chart for handing interrupts caused by trigger events in accordance with various non-exclusive embodiments of the invention.

FIGS. 19A-19B are tables listing various types of interrupts and haptic alerts in accordance with various non-exclusive embodiments of the invention.

It should be noted that like reference numbers refer to like elements in the figures.

### DETAILED DESCRIPTION

The present invention will now be described in detail with reference to several embodiments thereof as illustrated in the accompanying drawings. In the following description, numerous specific details are set forth in order to provide a thorough understanding of embodiments of the present invention, including the description of a plurality of different aspects of the invention, including, in some case, one or more alternatives. It will be apparent to those skilled in the art that the invention can be practice without implementing all of the features disclosed herein.

The Applicant has proposed various vehicle platooning systems in which a second, and potentially additional, vehicle(s) is/are automatically, or semi-automatically controlled to closely follow a lead vehicle in a safe manner By way of example, U.S. application Ser. Nos. 15/605,456, 15/607,902; 13/542,622, 15/860,333 and 13/542,627; U.S. Provisional Application Nos. 62/377,970 and 62/343,819; and PCT Application Nos. PCT/US2014/030770, PCT/US2016/049143, PCT/US2017/047825 and PCT/US2016/060167 describe various vehicle platooning systems in which a trailing vehicle is at least partially automatically controlled to closely follow a designated lead vehicle. Each of these earlier applications is incorporated herein by reference.

One of the goals of platooning is typically to maintain a desired longitudinal distance between the platooning vehicles, which is frequently referred to herein as the “desired gap”. That is, it is desirable for the trailing vehicle (e.g., a trailing truck) to maintain a designated gap relative to a specific vehicle (e.g., a lead truck). The vehicles involved in a platoon will typically have sophisticated control systems suitable for initiating a platoon, maintaining the gap under a wide variety of different driving conditions, and gracefully dissolving the platoon as appropriate.

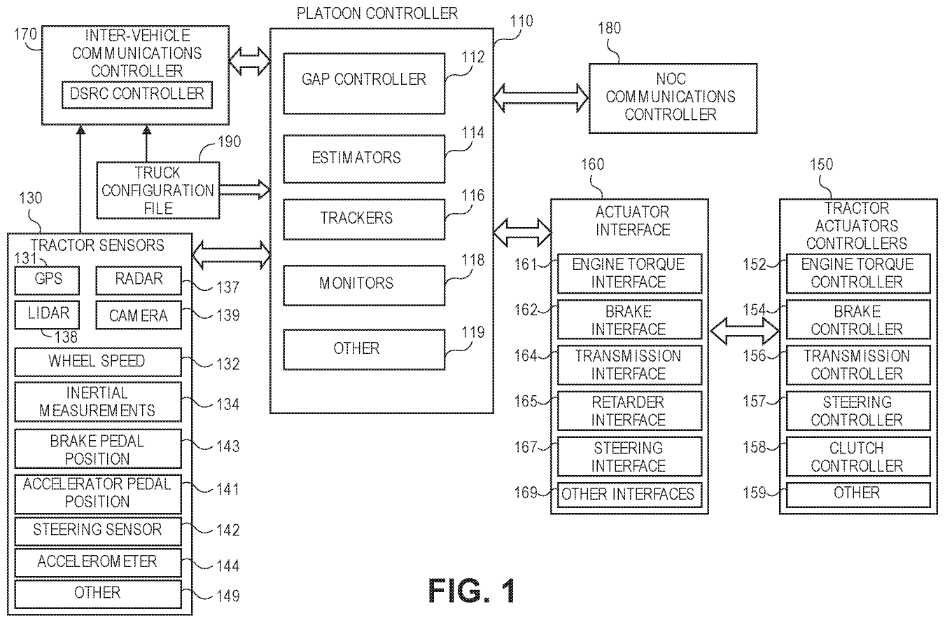

The architecture and design of control systems suitable for implementing vehicle platooning may vary widely. The specific controller design can vary based on the level of automation contemplated for the controller, as well as the nature of and equipment available on the host vehicles participating in the platoon. By way of example, FIG. 1 diagrammatically illustrates a vehicle control architecture that is suitable for use with platooning tractor-trailer trucks. The specific controller illustrated is primarily designed for use in conjunction with a platooning system in which both vehicles include an active driver. The driver of the lead vehicle being fully responsible for control of the front vehicle. The driver of the trailing vehicle is responsible for steering the trailing vehicle, but the platoon controller 110 is primarily responsible for controlling the trailing vehicles torque and braking requests during active platooning. However, it should be appreciated that generally similar control schemes can be used in systems which contemplate more automated control of one or both of the platoon partners or which utilize vehicle control commands other than or in addition to torque and braking requests.

In the illustrated embodiment illustrated in FIG. 1, a platoon controller 110, receives inputs from a number of sensors 130 on the tractor and/or one or more trailers or other connected units, and a number of actuators and actuator controllers 150 arranged to control operation of the tractor's powertrain and other vehicle systems. An actuator interface 160 may be provided to facilitate communications between the platoon controller 110 and the actuator controllers 150. The platoon controller 110 also interacts with an inter-vehicle communications controller 170 which orchestrates communications with the platoon partner and a NOC communications controller 180 that orchestrates communications with a network operations center (NOC). The vehicle also preferably has selected configuration files 190 that include known information about the vehicle.

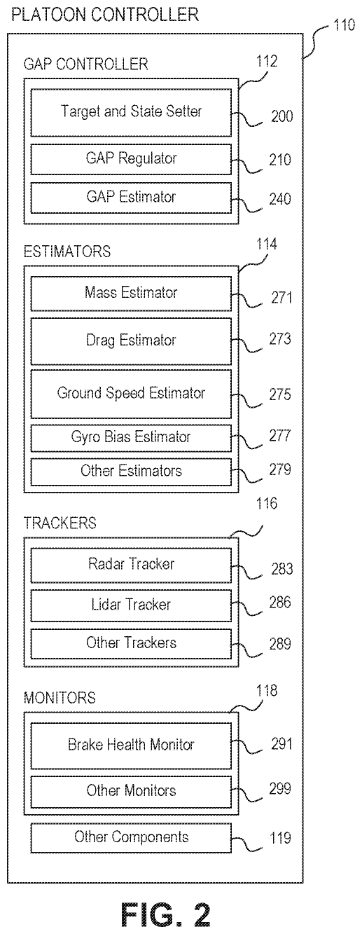

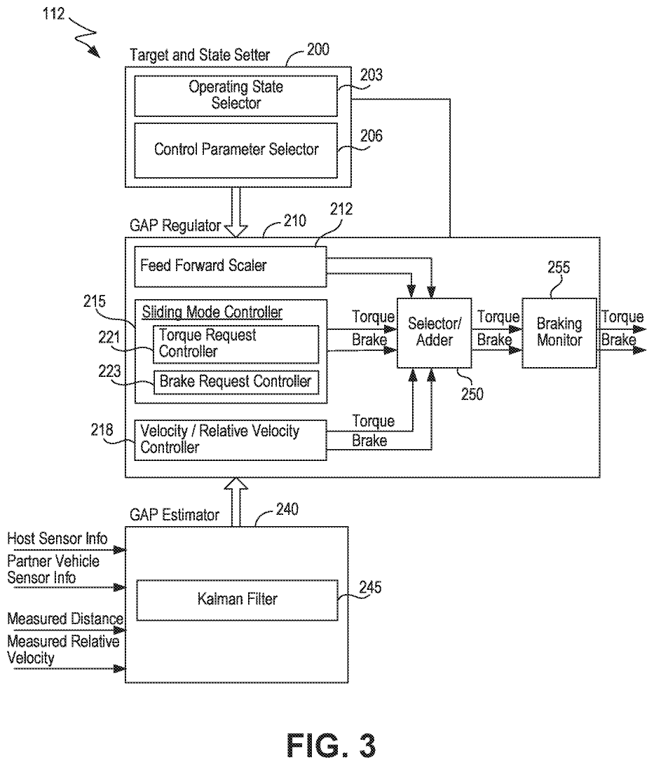

Some of the functional components of the platoon controller 110 include gap controller 112, a variety of estimators 114, one or more partner vehicle trackers 116 and various monitors 118. In many applications, the platoon controller 110 will include a variety of other components 119 as well. Exemplary embodiments of the platoon controller 110 and gap controller 112 are described in more detail below with reference to FIGS. 2 and 3.

Some of the sensors utilized by the platoon controller 110 may include GNSS (GPS) unit 131, wheel speed sensors 132, inertial measurement devices 134, radar unit 137, lidar unit 138, cameras 139, accelerator pedal position sensor 141, steering wheel position sensor 142, brake pedal position sensor 143, and various accelerometers 144. Of course, not all of these sensors will be available on all vehicles involved in a platoon and not all of these sensors are required in any particular embodiment. A variety of other sensor 149 (now existing or later developed or commercially deployed) may be additionally or alternatively be utilized by the platoon controller in other embodiments. In the primary embodiments described herein, GPS position data is used. However, GPS is just one of the currently available global navigation satellite systems (GNSS). Therefore, it should be appreciated that data from any other GNSS system or from other suitable position sensing systems may be used in place of, or in addition to the GPS system.

Many (but not all) of the described sensors, including wheel speed sensors, 132, radar unit 137, accelerator pedal position sensor 141, steering wheel position sensor 142, brake pedal position sensor 143, and accelerometer 144 are relatively standard equipment on newer trucks (tractors) used to pull semi-trailers. However, others, such as the GNSS unit 131 and lidar unit 138 (if used) are not currently standard equipment on such tractors or may not be present on a particular vehicle and may be installed as needed or desired to help support platooning.

Some of the vehicle actuators controllers 150 that the platoon controller may direct at least in part include engine torque controller 152 (which is often part of the integrated functionality of an engine control unit (ECU) or powertrain control module (PCM)); brake controller 154; transmission controller 156; steering controller 157 (when automated steering is provided); and clutch controller 158. Of course, not all of these actuator controllers will be available or are required in any particular embodiment and it may be desirable to interface with a variety of other vehicle actuator controllers 159 that may be available on the controlled vehicle as well. Therefore, it should be appreciated that the specific actuator controllers 150 directed or otherwise utilized by the platoon controller on any particular controlled vehicle may vary widely. Further, the capabilities of any particular actuator controller (e.g. engine torque controller 152), as well as its interface (e.g., the nature and format of the commands, instructions, requests and messages it can handle or generate) will often vary with the make and model of that particular actuator controller. Therefore, an actuator interface 160 is preferably provided to translate requests, commands, messages and instructions from the platoon controller 110 into formats that are appropriate for the specific actuator controller hardware and software utilized on the controlled vehicle. The actuator interface 160 also provides a mechanism for communicating/translating messages, commands, instructions and requests received from the various actuator controllers back to the platoon controller 110. Typically an appropriate actuator interface would be provided to interact with each of the specific vehicle controllers utilized. In various embodiments, this may include one or more of: an engine torque interface 161; a brake interface 162; a transmission interface 164; a retarder interface 165 (if a separate retarder controller is used); a steering interface 167; and/or any other appropriate controller interface 169.

Large trucks and other heavy vehicles frequently have multiple systems for “braking” the truck. These include the traditional brake system assemblies mounted in the wheels of the vehicle—which are often referred to in the industry as the “foundation brakes.” Most large trucks/heavy vehicles also have a mechanism referred to as a “retarder” that is used to augment the foundation brakes and serve as an alternative mechanism for slowing the vehicle or to help prevent the vehicle from accelerating down a hill. Often, the retarder will be controlled by the engine torque controller 152 and in such embodiments, the retarder can be controlled by sending appropriate torque commands (which may be negative) to the engine torque controller 152. In other embodiments a separate retarder controller (not shown) may be accessible to, and therefore directed by, platoon controller 110 through an appropriate retarder interface 165. In still other embodiments, the platoon controller 110 may separately determine a retard command that it sends to the actuator interface 160. In such embodiments the actuator interface will interpret the retard command and pass on appropriate retardation control commands to the ECU or other appropriate vehicle controller.

The communications between vehicles may be directed over any suitable channel and may be coordinated by inter-vehicle communications controller 170. By way of example, the Dedicated Short Range Communications (DSRC) protocol (e.g. the IEEE 802.11p protocol), which is a two-way short to medium range wireless communications technology that has been developed for vehicle-to-vehicle communications, works well. Of course, other communications protocols and channels may be used in addition to or in place of a DSRC link. For example, the inter-vehicle communications may additionally or alternatively be transmitted over a cellular communications channel such as 4G LTE Direct, 5G, a Citizen's Band (CB) Radio channel, one or more General Mobile Radio Service (GMRS) bands, one or more Family Radio Service (FRS) bands, Wi-Fi, Zigbee or any other now existing or later developed communications channels using any suitable communication protocol.

The specific information transmitted back and forth between the vehicles may vary widely based on the needs of the controllers. In various embodiments, the transmitted information may include the current commands generated by the platoon controller 110 such as requested/commanded engine torque 280, requested/commanded braking deceleration 282. They may also include steering commands, gear commands, etc. when those aspects are controlled by platoon controller 110. Corresponding information is received from the partner vehicle, regardless of whether those commands are generated by a platoon controller or other suitable controller on the partner vehicle (e.g., an adaptive cruise control system (ACC) or a collision mitigation system (CMS)), or through other or more traditional mechanisms—as for example, in response to driver inputs (e.g., accelerator pedal position, brake position, steering wheel position, etc.).

In many embodiments, much or all of the tractor sensor information provided to platoon controller 110 is also transmitted to the platoon partner and corresponding information is received from the platoon partner so that the platoon controllers 110 on each vehicle can develop an accurate model of what the partner vehicle is doing. The same is true for any other relevant information that is provided to the platoon controller, including any vehicle configuration information 190 that is relevant to the platoon controller. It should be appreciated that the specific information transmitted may vary widely based on the requirements of the platoon controllers 110, the sensors and actuators available on the respective vehicles, and the specific knowledge that each vehicle may have about itself.

The information transmitted between vehicles may also include information about intended future actions. For example, if the lead vehicle knows it is approaching a hill, it may expect to increase its torque request (or decrease its torque request in the context of a downhill) in the near future and that information can be conveyed to a trailing vehicle for use as appropriate by the platoon controller 110. Of course, there is a wide variety of other information that can be used to foresee future torque or braking requests and that information can be conveyed in a variety of different forms. In some embodiments, the nature of the expected events themselves can be indicated (e.g., a hill, or curve or exit is approaching) together with the expected timing of such events. In other embodiments, the intended future actions can be reported in the context of expected control commands such as the expected torques and/or other control parameters and the timing at which such changes are expected. Of course, there are a wide variety of different types of expected events that may be relevant to the platoon control.

The communications between the vehicles and the NOC may be transmitted over a variety of different networks, such as the cellular network, various Wi-Fi networks, satellite communications networks and/or any of a variety of other networks as appropriate. The communications with the NOC may be coordinated by NOC communications controller 180. The information transmitted to and/or received from the NOC may vary widely based on the overall system design. In some circumstances, the NOC may provide specific control parameters such as a target gap tolerance. These control parameters or constraints may be based on factors known at the NOC such as speed limits, the nature of the road/terrain (e.g., hilly vs. flat, winding vs. straight, etc.) weather conditions, traffic or road conditions, etc. In other circumstances the NOC may provide information such information to the platoon controller. The NOC may also provide information about the partner vehicle including its configuration information and any known relevant information about its current operational state such as weight, trailer length, etc.

The configuration file 190 may include a wide variety of information about the host vehicle that may be considered relevant to the controller. By way of example, some of the information might include the vehicle's specification including such things as engine performance characteristics, available sensors, the nature of its braking system, the location of its GNSS antenna relative to the front of the cab, gear ratios, differential ratios etc.

FIG. 2 illustrates a particular embodiment of a platoon controller 110. In the illustrated embodiment, the platoon controller 110 includes a gap controller 112, a plurality of estimators 114, one or more trackers 116, any desired monitors 118 and potentially any of a variety of other components 119.

In the illustrated embodiment, the gap controller 112 includes a target and state setter 200, a gap regulator 210 and a gap estimator 240. In general, the target and state setter 200 is arranged to determine the intended operational mode (state) of the gap regulator 210 and the values of any variable control parameters that are appropriate for use in that operational mode.

The gap regulator 210 is arranged to control the trailing platoon partner in the manner designated by the target and state setter 200. In the gap control operational mode, the gap regulator 210 controls the vehicle in a manner that seeks to attain and maintain the desired gap in accordance with any designated control parameters specified by the state setter 200. In other modes, the gap regulator 210 controls the vehicle in a manner that seeks to attain the appropriate response for the selected operational mode.

The gap estimator 240 is arranged to estimate/determine the current gap based on actual measurements and/or other information that is available to the platoon controller 110. It should be apparent that an accurate understanding of the current gap is important to successful operation of the gap regulator. At the same time, it should be appreciated that any measurement system has inherent tolerances and can be subject to reporting errors and/or may become unavailable in some circumstances. Thus, the gap estimator 240 is configured to receive information from multiple position or relative position related sensors and to fuse such data into a reliable estimate of the current gap.

The torque and braking requests generated by GAP regulator 210 are sent to the appropriate actuator interface (e.g., engine torque interface 161 and brake interface 162 respectively). The engine torque interface 161 then forwards an appropriate torque command to engine torque controller 152 which directs the delivery of the requested torque by directing various engine operating parameters such as fuel charge, valve timing, retarder state, etc. appropriately. The brake interface 162 generates an appropriate brake request that is sent to the brake controller 156.

A particular embodiment of gap controller 112 is described in more detail below with reference to FIG. 3.

Returning to FIG. 2, there are a variety of estimators 114 that are useful for the gap controller 112. In various embodiments these may include one or more of a mass estimator 271, a drag estimator 273, a ground speed estimator 275, a gyro bias estimator 277 and/or other estimators 279.

The mass estimator 271 is arranged to estimate the respective masses of the platoon partners. These mass estimations may be used by the gap controller 112 to help scale its torque and brake requests appropriately based on the respective weights (masses) of the platoon partners.

The drag estimator 273 is arranged to estimate the respective drag resistances of the platoon partners. These drag resistance estimates may also be used by the gap controller to help adjust its torque and brake requests appropriately. In general, the drag resistance of any particular truck or other vehicle can vary based on a variety of factors including: (a) its drag profile (which in the context of a truck may change based on the trailer being pulled—if any, or other characteristics of the load); (b) the vehicle's current speed, (c) wind speed and direction, (d) rolling resistance, (e) platoon state (e.g., whether a platoon is active, the position of the vehicle within the platoon, the gap), (f) bearing wear, etc.

The ground speed estimator 275 is arranged to estimate the actual ground speed of the respective platoon partners. Many trucks and other vehicles have wheel speed sensors that can quite accurately measure the rotational speed of the associated wheels. The actual ground speed at which the vehicles are traveling will vary based on the respective diameters of the wheels and slip conditions of the tires. The precise diameter of the wheels can vary based on the tires used. Furthermore, the diameter of the wheels will vary over time with tire wear, changes in ambient temperature and other factors. The wheel diameter will even change over the course of a particular trip as the tires heat up (or otherwise change in temperature) during use. In practice, all of these variations in wheel diameter are potentially significant enough to impact the gap estimation and gap control. Therefore, the ground speed estimator 275 is arranged to estimate the actual ground speed based on measured wheel speed and other available information such as GNSS information. The ground speed estimates are particularly useful in times when tracker-based gap measurements (e.g., radar, cameras, lidar, ultrasound etc.) aren't available—which may occur, for example, when the platoon partners are laterally offset due to a lane change, etc.

Several of the measurements utilized by the gap controller 112 are inertial measurements that are gyro based. These may include yaw measurements which indicate the rate at which the associated vehicle is turning, longitudinal acceleration measurements, etc. Gyros often have an inherent measurement error referred to as a gyro bias that can affect measurements. The gyro bias estimator 277 estimates such biases to allow the gap controller to compensate for such gyro-based measurement errors.

The platoon controller 110 can include any other estimators 279 that may be useful to any particular gap controller 112 as well.

The platoon controller 110 may also include one or more trackers 116. Each tracker 116 is arranged to measure or otherwise determine the gap. One type of tracker that is used in many implementations is a radar-based radar tracker 283. Newer commercially available trucks often come equipped with a radar unit as standard equipment and radar trackers are particularly well suited for use in such vehicles. Of course, one or more radar units may be installed on any vehicle that does not come pre-equipped with a radar unit to facilitate use of radar tracker 283. By way of example, some specific radar trackers are described in more detail in co-pending U.S. application Ser. Nos. 15/590,715 and 15/590,803, both filed May 9, 2017, both of which are incorporated herein by reference.

Lidar is another distance measuring technology that is well suited for measuring the gap between vehicles. Lidar is quickly gaining popularity for use in automated and autonomous driving applications. Lidar tracker 286 is well suited for use on vehicles that have or are provided with lidar units. Cameras and stereo cameras are also becoming more popular distance measuring tools for use in various automated and autonomous driving applications.

Of course, other distance measuring technologies can be used to measure or estimate the gap between vehicles as represented by other trackers 289. By way of example, a GPS tracker could be used that is based primarily on the respective reported GPS positions of the vehicles. In another example, ultrasound-based distance measuring unit may be used.

The tracker(s) used in many embodiments are configured to fuse data from multiple sensors to help validate the measurements of the primary sensors used by the respective trackers. The aforementioned radar tracker application describes a variety of methods for fusing data to help validate measurements of a primary sensor in that manner.

In various embodiments, the gap estimator 240 could replace or be replaced by one or more of the trackers, or could be thought of as a tracker itself since it determines/estimates the gap based on inputs from multiple sensors. In the illustrated embodiment, the gap estimator 240 is shown separately as part of gap controller 112 since it fuses distance data from the tracker(s) and any other available sources such as GNSS sensors on each of the vehicles.

The platoon controller 110 may also include one or more monitors 118 that are configured to monitor specific components that are relevant to gap control. By way of example, one specific monitor that is particularly useful to the control of platooning trucks is brake health monitor 291. The brake health monitor 291 is configured to monitor the brake system and to identify circumstances in which the brakes may not be able to deliver the level of braking normally expected for platoon control—as for example could occur if the foundation brakes include drum brakes that have been used while traveling downhill in the mountains to the extent that they are close to overheating. If the brake health monitor 291 identifies such a circumstance, it informs the platoon controller, which can take the appropriate remedial action. The appropriate remedial action will vary based on the specific circumstances identified by the brake health monitor, but may include, for example, actions such as dissolving the platoon, increasing the target gap to a level more appropriate for the brake conditions, etc. Of course, the brake health monitor can also be configured to identify circumstances in which the condition of the brakes has improved (e.g., the brakes have cooled sufficiently) and inform the platoon controller of those circumstances as well so that the platoon controller can act accordingly. For example, improved braking status may allow the target gap to be reduced, a platoon to be reestablished or other appropriate actions.

The platoon controller may include any of a variety of other monitors 299 that are configured to monitor the state or status of other components, systems, environmental conditions, road or traffic conditions, etc. that may be relevant to platoon control. For example, a DSRC link monitor may be provided to monitor the status of a DSRC communication link between the platoon partners.

Referring next to FIG. 3, another embodiment of gap controller 112 will be described in more detail. Similar to the embodiment illustrated in FIG. 2, the gap controller 112 includes a target and state setter 200, a gap regulator 210 and a gap estimator 240. In the embodiment of FIG. 3, the target and state setter 200 includes an operating state selector 203, and a control parameter selector 206 that determines, selects, sets or otherwise indicates to the gap regulator the values of any variable control parameters that are appropriate for use in the selected operational mode.

The operating state selector 203 is arranged to determine the intended operational mode (state) of the gap regulator 210. In some specific embodiments, the operational modes might include a “normal” or “gap control” operational mode in which the gap regulator is configured to control towards attaining and maintaining a designated gap between the vehicles. In the gap control operational mode control parameter variables dictated by the control parameter selector might include the target gap itself (e.g., 10m, 12m, etc.)—which may vary somewhat based on driving conditions (e.g., weather, terrain, road conditions, traffic, etc.). Other control parameters during normal operation may include parameters that impact the draw-in speed, the tightness of the control, tolerances or variations between torque control and braking control, etc. In other embodiments, “initiate platoon” and/or “draw-in” or “pull-in” may be one or more separate states that are used to establish a platoon and/or to bring the platoon partners together in a safe manner under at least partially automated control.

Another potential operational mode is a “dissolve” mode in which the platoon controller transitions the trailing vehicle toward/to a position at which the driver of the trailing vehicle (or an automatic cruise control system) can safely take over control of the vehicle. Generally, dissolving a platoon includes increasing the gap between the vehicles in a controlled manner to/towards a point at which the platoon can be dissolved and vehicle control can be safely transferred to manual control by the driver or to control through the use of a different system such as adaptive cruise control. The dissolve mode may optionally be triggered by a wide variety of different circumstances, as for example, in response to one of the platoon partners or the NOC deciding to terminate the platoon; the detection of a car cutting-in between the platooning vehicles; the loss of communications between the vehicles for an extended period; the detection of an object in front of the lead vehicle that is too slow or too close to the platoon; etc.

Another potential operational mode may be a velocity control or relative velocity control mode. Velocity control, or relative velocity control may be preferable to trying to control to maintain a particular gap in a variety of specific circumstances—as for example when the trailing vehicle's radar (or other) tracking unit loses sight of the partner vehicle, as can occur when there is a lateral offset between the vehicles due to a lane change or other conditions.

Of course, there can be a variety of other operational modes as well.

The gap regulator 210 is arranged to control the trailing platoon partner in the manner designated by the target and state setter 200. In the embodiment illustrated in FIG. 3, the gap regulator 210 includes a scaler 212 and two separate controllers which are used in different combinations in different operating modes. In the illustrated embodiment, the controllers include a sliding mode controller 215 (which performs gap control) and a velocity/relative velocity controller 218. It should be appreciated that in other embodiments, a single controller, additional and/or different may be provided as appropriate for any particular implementation.

In the illustrated embodiment, the feed forward scaler 212 is configured to scale the torque and brake signals from the front vehicle before adding them to the outputs from the sliding mode and relative velocity controllers 215, 218 to create the torque and brake request to the engine and brake controllers. Such scaling may be based on factors such as the respective weights (masses) of the platoon partners, the respective drags of the vehicles, the severity of a braking event (e.g., in high braking scenarios, the braking command may be increased a bit to provide a margin of safety to account for uncertainties in braking performance and reactions times), etc. In other embodiments, such scaling functions can be integrated into the respective controllers themselves if desired.

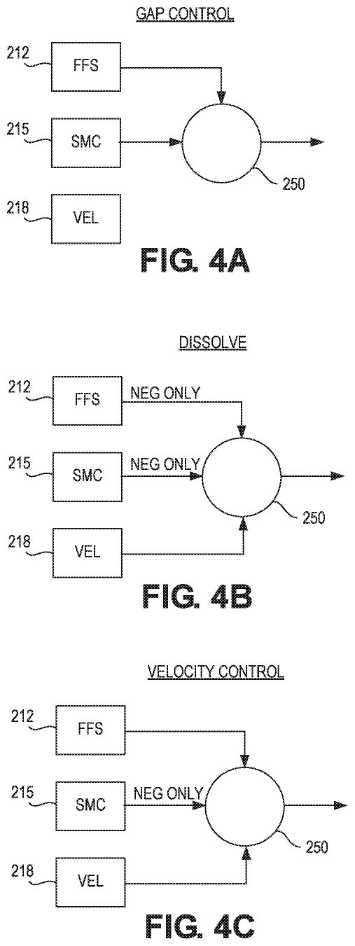

The sliding mode controller 215 is configured to control the trailing vehicle in a manner that seeks to attain and maintain the desired gap in accordance with the target gap and any other control parameters specified by the control parameter selector 206. Thus, its primary function is gap control. The velocity controller 218 is configured to control the trailing vehicles in a manner that maintains a designated velocity relative to the lead vehicle, or in some circumstances, simply a designated velocity. In the illustrated embodiment, these two separate controllers are provided so that the gap regulator 210 can provide different types of control, as may be appropriate in different operational circumstances. A few specific examples are described with reference to FIGS. 4A-4C. In the described embodiments, both the controllers 215 and 218 are operated continuously during platooning and the selector/adder 250 is used to select the appropriate signals to output based on the current operating mode. An optional braking monitor 255 is a safety feature that may be utilized to help ensure that the brake commands outputted by selector/adder 250 don't overly aggressively brake the trailing vehicle except in where necessary from a safety/crash prevention standpoint. This is to reduce the risk of traffic behind the trailing platoon partner from being impacted by unexpected aggressive braking of the trailing platoon partner.

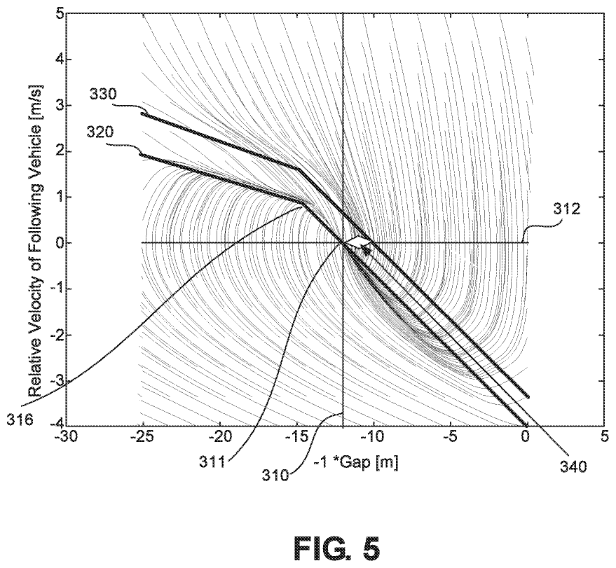

The sliding mode controller 215 is arranged to control the trailing vehicle in a manner such that its relative velocity relative to the front vehicle varies as a function of the gap between the vehicles. This characteristic is illustrated in the state space diagrams of FIG. 5 which show a control scheme in accordance with one specific implementation. More specifically, FIG. 5 plots relative velocity between the vehicles (the Y-axis) vs. gap between the vehicles (the X-axis). FIG. 5 also shows a torque request controller target control line 320. In the illustrated embodiment, the nominal desired gap is 12 meters—which is represented by line 310. Thus, the target control point 311 is 12 meters with zero relative velocity, which is the point represented by the intersection of line 310 (12 meters gap) and line 312 (zero relative velocity).

The torque request controller component 221 of gap regulator 210 is configured to generate a torque request that is appropriate to control the gap in accordance with target control line 320. The torque request is then implemented by engine torque controller 152. As can be seen in FIG. 5, when the gap is larger than the desired gap, the rear truck is controlled to travel slightly faster than the front truck is traveling such that the relative velocity of the rear truck has a small positive value. As the rear truck draws closer to the lead truck, its relative velocity is reduced in a smooth manner until the gap is reduced to the target control point 311, at which point the relative velocity would be zero if perfect control were attained. If the rear truck gets closer than the desired gap, it is slowed so that it has a negative relative velocity relative to the lead truck to reestablish the desired gap.

The sliding mode controller 215 utilizes a unified sliding mode control scheme during both the “pull-in” and gap maintenance stages of platooning. Configuring the sliding mode controller to control towards target control line 320 helps ensure that the relative speed vs. gap relationship stays within a region safe for platooning.

In the embodiment illustrated in FIG. 3, the sliding mode controller 215 includes separate controllers (e.g. torque request controller 221 and brake request generator components 223) which are configured to control towards different gap control targets. The different control targets are illustrated in the state space diagrams of FIG. 5 which show a control scheme in accordance with one specific implementation. More specifically, FIG. 5 shows a brake request controller target control line 330 in addition to torque request controller target control line 320. FIG. 5 additionally shows representative transition paths from various points in the state space to the torque request target control line 320.

For most open highway driving conditions, modulating the torque request alone is sufficient to control the gap appropriately without requiring the use of the foundation brakes. This is in part because the torque request can be negative to a certain degree without needing to actuate the foundation brakes through the use of engine braking and/or the retarder (if available). As mentioned above, when fuel is cut-off there will be some pumping losses and some frictional losses in the powertrain, so some level of negative torque can be provided while using normal valve timing by simply reducing the fuel charge appropriately. When larger negative torque is needed, the engine torque controller 152 can create larger negative torques by actuating the retarder and/or by taking other appropriate measures.

Separately, the brake request controller component 223 of gap regulator 210 is arranged to generate brake requests during normal operation that are generally arranged to maintain a different gap—specifically a smaller gap—than the torque request controller 221 targets. This difference in the gaps that the torque and brake request controllers control is sometimes referred to herein as the gap tolerance 340. In general, brake requests 213 are not generated unless or until the gap is reduced at least to a gap tolerance below the torque request target control line 320. Since the brakes can only be used to slow the vehicle, the effect of this difference is that the trailing truck will be allowed to creep in a relatively small amount (2 meters in the example) before the foundation brakes are actuated when the gap regulator 210 cannot maintain the desired gap through control of the torque request alone. When the desired gap can be restored by modulating the torque requests alone without crossing target brake control line 330, then the foundation brakes do not need to be used at all. This has the effect of safely maintaining a gap while reducing the probability that the foundation brakes will be deployed unnecessarily.

Normal gap control is illustrated in FIG. 4A. During normal gap control, the sliding mode controller 215 is used to determine torque and brake requests that are appropriate to attain and maintain the target gap set by control parameter selector 206. When appropriate, the torque and brake requests generated by the sliding mode controller 215 may be scaled appropriately by selector/adder 250 based on inputs from feed forward scaler 212. In this normal gap control mode, the outputs of the relative velocity controller 218 are not used in the control of the trailing vehicle.

In some embodiments, the sliding mode controller 215 includes separate torque request and brake request controllers 221, 223 as illustrated in FIG. 3. The torque request and brake request controllers 221, 223 are configured to control the engine and brakes respectively towards different gap targets which tends to provide a smoother, more comfortable ride and reduce the use of wheel brakes (e.g., the foundation brakes in tractor-trailer rigs) compared to control in which the engine and brakes are controlled to the same target gap. Such a gap control architecture is described in more detail in U.S. Provisional application No. 62/489,662, which is incorporated herein by reference.

Although the sliding mode controller 215 works very well to control the gap, there will be operational circumstances in which different types of control may be appropriate. For example, a different type of control may be desirable when it is necessary to dissolve a platoon and return the trailing vehicle to manual or other automated control. Typically, the gap between vehicles during platooning will be smaller, often much smaller, than can safely be maintained by a driver under manual control. Therefore, in general, when a platoon is dissolved with the intent to restoring manual control of the trailing vehicle, it will be desirable to grow the gap to a distance that is appropriate for manual control before relinquishing control to the driver. This can be accomplished in a smooth manner by relative velocity controller 218.

When operating state selector 203 determines that the platoon should be dissolved, it directs the GAP regulator 210 to transition to a dissolve mode as represented by FIG. 4B. In the dissolve mode, primary control is provided by relative velocity controller 218. The control parameter selector 206 may designate a desired (target) relative velocity for the trailing truck during the dissolve. The specific target relative velocity may vary based on the nature of the circumstances and/or the vehicles involved in the platoon. In general, it is desirable to select a relative velocity that will cause the vehicles to gradually, but expeditiously separate, without requiring the trailing vehicle to slow excessively (which could unduly hinder following traffic) and preferably without requiring the lead vehicle to alter its drive plan. By way of example, relative velocities during dissolves on the order of 0.5 to 4 meters per second, as for example, 1-2 m/s, have been found to work well in the context of platooning trucks.

During a dissolve, the lead vehicle may take a variety of actions. For example, the lead truck may accelerate or increase its torque command aggressively. In such cases, it may not be desirable to try to accelerate the trailing truck in a similar manner thereby allowing the lead vehicle to pull away more than would otherwise occur under relative velocity control. One way to accomplish this in the context of platooning trucks is to ignore or otherwise disable positive torque commands from feed forward scaler 212.

Another potential scenario is that the lead truck brakes or slows significantly while under velocity control. In some circumstances, the velocity controller 218 may be configured to permit a certain amount of gap shrinkage when the gap is relatively larger to thereby reduce the overall amount of braking required. In the illustrated embodiment, the sliding mode controller is configured to ensure that the gap between the vehicles is always sufficient to give the trailing vehicle sufficient time to respond in a manner that prevents the trailing vehicle from running into the back of the lead vehicle regardless of the occurrence of (reasonable) unexpected events. Therefore, if the sliding mode controller is outputting a braking or negative torque signal that has a greater magnitude than the relative velocity controller, then that larger braking/negative torque command should be passed to the vehicle's engine and braking controllers. Therefore, during a dissolve, the selector/adder 250 is configured to only utilize negative commands (i.e., braking commands and negative torque commands) from the sliding mode controller 215 and to only use such commands when they are greater in magnitude than the commands from the relative velocity controller 218.

There may also be operational circumstances outside of dissolves in which relative velocity control or simply velocity control is desired. For example, there may be circumstances in which the back of the lead vehicle moves out of view of the trailing vehicle's tracker(s) 116 or the tracker(s) 116 otherwise loses sight of the back of the platoon partner. This can occur, for example, as a result of a lane change by one of the platoon partners. In such a circumstance the gap regulator may not have an accurate measure of the longitudinal gap between the vehicles—and may have to rely on less accurate approaches for determining the gap such as the vehicle's respective GNSS positions. In such circumstances, it may be desirable to control the trailing vehicle to slowly drop back until the back of the lead vehicle comes within the tracker's view. Again, the relative velocity controller 218 is well suited for use in this circumstance—although the preferred relative velocity control may be a bit different than occurs during a dissolve. Specifically, the goal is typically not to drop back as quickly or as far as would occur during a dissolve—thus a smaller relative velocity (e.g. 0.5 m/s vs. 2 m/s), may be appropriate.

One approach to such relative velocity control is illustrated in FIG. 4C. In the velocity control scheme of FIG. 4C velocity controller 218 is used in conjunction with normal scaling from feed forward scaler 212. This causes the trailing platoon partner to better follow lead vehicle accelerations and/or torque increases than occurs during the dissolve state illustrated in FIG. 4B. At the same time, for safety purposes, braking requests and negative torque request from the sliding mode controller 215 may be utilized as appropriate by selector/adder 250 in a manner similar to the approach described above with respect to FIG. 4B.

### Safety Focused Architecture

When developing an autonomous vehicle controller, it is important for the system to be safe (truly safe). It is also important for the system to be verifiably safe. That is, it is desirable to be able to verify with a high degree of confidence that the system is safe. As discussed in the background, some standards organizations and governments have promulgated guidelines and/or standards intended to classify the safety risks associated with vehicle operation. One such effort is the Automotive Safety Integrity Level (ASIL) risk classification scheme defined by ISO 26262—Functional Safety for Road Vehicles standard. There are currently four safety integrity levels identified by the ASIL standard: ASIL-A, ASIL-B, ASIL-C, and ASIL-D. ASIL-D represents the highest integrity requirements and ASIL-A corresponds to the lowest level compliance requirements of the defined standards. Matters that are not directly covered by the standard are identified as QM for “Quality Management” which from the context of ASIL, means that their integrity levels are not represented to fall within the copy of any of the ASIL standards.

There are potentially significant advantages to making a platoon control system verifiably safe, as for example, by making the platoon controller ASIL compliant (and/or compliant with other safety integrity level standards). Most notably, many ECUs, powertrain control modules (PCMs) and other controllers used in commercially available road vehicles are designed to expect that all commands that they receive come from ASIL compliant components that conform to a particular minimum ASIL level—as for example, at the ASIL-C level or higher. Therefore, it is desirable for control commands issued from the platooning system to be ASIL rated or to meet other designated reliability criteria or standards. It is also desirable for the overall system to be safe to some chosen level. Processes and standards like ISO 26262 are also useful to guide the development of safe systems.

ASIL compliance is a rigorous standard which requires extensive command integrity checking and data verification. In general, data used in ASIL integrity checking must come from, or be verified by ASIL compliant devices of at least the same integrity level. Inputs from QM rated devices (or lower level ASIL devices) may be used in ASIL compliant devices, as long as the reasonableness of their commands or data are verified by the ASIL device to the appropriate standards.

Some of the data used in platoon control (such as GPS position data) cannot itself be readily verified to a level required by ASIL. As such, it can be challenging to design every component in the entire platoon control system in a manner that meets the ASIL standards and thus ensures that the commands are proper to achieve safety targets. Therefore, it can be useful to divide the platoon control system into distinct QM and ASIL components (or different ASIL level components), with all of the components that send instructions directly to any of the vehicles control systems being ASIL compliant (or compliant to the higher ASIL level).

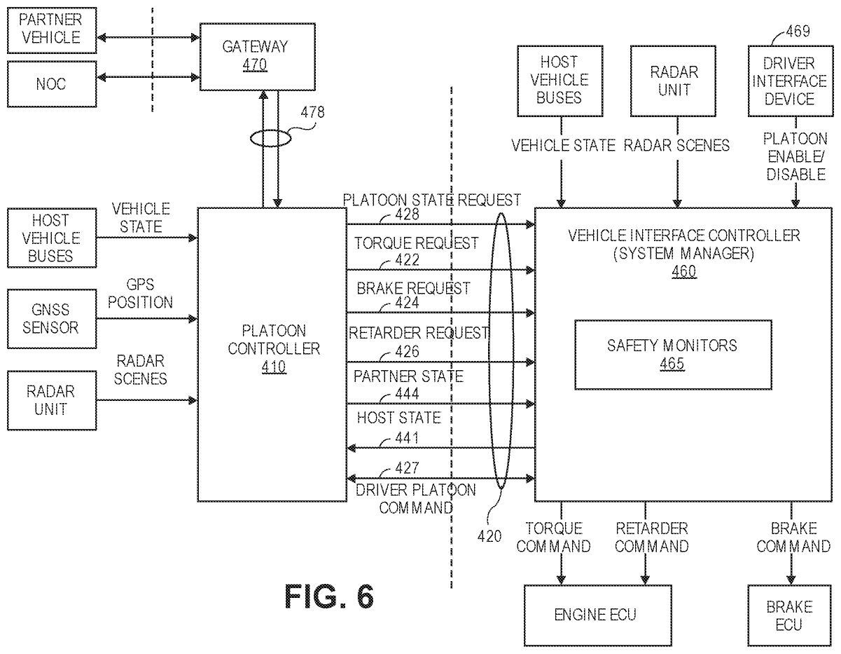

FIG. 6 illustrates a platoon control system hardware architecture that is particularly well suited suitable for ASIL compliant platoon control. The illustrated embodiment includes three separate controller hardware units. These include platoon controller 410, vehicle interface controller 460 and gateway processor 470.

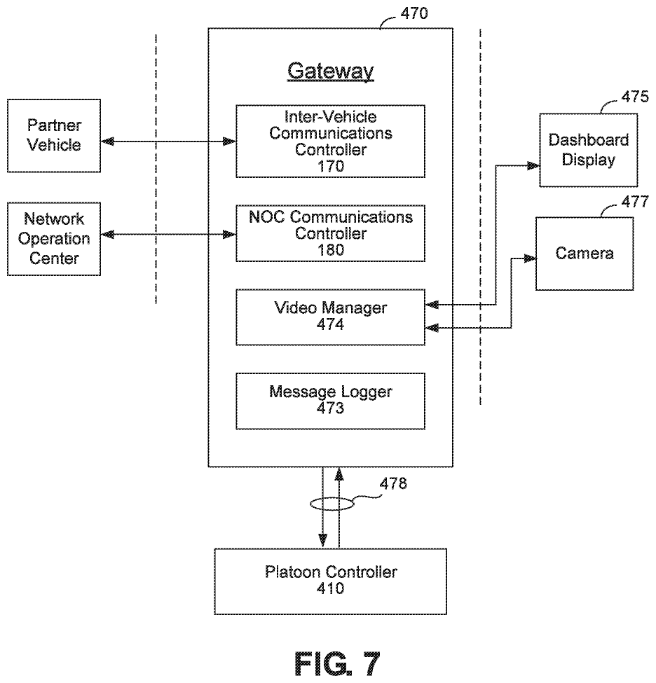

Selected components of a representative gateway processor 470 are illustrated in FIG. 7. As best seen in FIG. 6, the platoon controller 410 communicates with the vehicle interface controller 460 through an interface 420 and with gateway 470 through a direct link 478. In some embodiments, the link 478 is a dedicated direct wired connection and no other devices are coupled to that link. The wired connection may be provided by any suitable form of cabling or traces, as for example co-ax cable, twisted pair wirings, fiber optics or any other suitable physical connection medium.

In the illustrated embodiment, the platoon controller 410 incorporates all of the functionality of platoon controller 110 described above. The vehicle interface controller 460 (also sometimes referred to as a system manager) performs the functionality of actuator interface 160 and further includes a number of safety monitors. In some embodiments, the safety monitors are arranged to execute ASIL compliant safety monitoring algorithms and the vehicle interface controller 460 is designed as an ASIL compliant device.

In general, the vehicle interface controller 460 includes a higher safety level processor and software (including the safety monitors) that independently verify the commands transmitted by the platoon controller 110 before they are passed on to the vehicle actuators. These verifications use a subset of the available sensor inputs, together with verification algorithms that are independent and distinct from those used by the platoon controller.

The gateway processor 470 is arranged to coordinate communications between a host vehicle and the platoon partner(s) and to coordinate communication between the host and the network operation center and/or any other entities that are external to the vehicle. As such, in a specific implementation of the system illustrated in FIG. 1 the gateway processor 470 includes the inter-vehicle communications controller 170 and NOC communication controller 180 as best illustrated in FIG. 7. Typically, the inter-vehicle communications controller utilizes a short-range, vehicle-to-vehicle wireless communications protocol, as for example the DSRC protocol. The NOC communication controller typically communicates with a networks operations center using cellular or satellite communications.

In some embodiments, the connection (link 478) between the gateway processor 470 and the platoon controller 410 is a dedicated direct wired connection and no other devices are coupled to the link. In some implementations an Ethernet or similar standardized wired communications protocol is used to pass information between the gateway processor and the platoon controller. This facilitates high speed, high reliability communications between the gateway processor and the platoon controller. In a specific example, a 100BASE or higher (e.g. 1000BASE, 10GBASE, etc.) Ethernet physical layer may be used, although it should be appreciated that a variety of other physical layers may be used in other embodiments.

In some embodiments, the gateway processor 470 is also arranged to communicate with a forward-facing camera 477 mounted on the vehicle and a dashboard display 475. When the host vehicle is the lead vehicle in a platoon, the gateway processor transmits a video feed received from the forward-facing camera 477 to the trailing vehicle(s) so that the driver of the trailing vehicle has a view of what is in front of the lead vehicle. When the host vehicle is a trailing vehicle in the platoon, the gateway processor 470 receives such a video feed from the gateway processor on the lead vehicle and transmits the feed to the dashboard display 475 where it is displayed to give the driver of the host vehicle a view of what is in front of the lead vehicle. Displaying a view of what is in front of the lead vehicle to drivers of a trailing vehicle is desirable since the to give the driver of the trailing vehicle a sense of comfort and the ability to independently react to situations that occur in front of the platoon. This can be particularly important because in many platoons (e.g. platoons that involve tractor trailer trucks) the trailing vehicle will be very close to the lead vehicle (much closer than normal manual driving) and the lead vehicle will effectively block the view of the trailing vehicle which can be an uncomfortable experience for drivers and/or passengers in a trailing platoon partner—especially when they do not have access to a view of what is going on in front of the platoon.

The video streams passed through the gateway may be managed by a video manager 474. Since the gateway 470 communicates directly with the camera 477 and/or dashboard display 475, the platoon controller 410 is not in any way burdened by the need to manage that data flow.

In some embodiments the gateway 470 also includes a message logger 473 that logs various messages and other information passed there through in order to provide a record for diagnostic purposes and the like. The functionality of the message logger 473 will be described in more detail below.

The platoon controller 410 is configured as a listener on any appropriate vehicle communications buses where it can directly obtain information about the vehicle's operational state—such as the vehicle's current wheel speed, any brake or accelerator pedal inputs, steering wheel position (as appropriate), transmission gear, etc. It is also coupled to sensor units such as GPS unit 131 to receive positional information about the location of the vehicle, and to forward looking radar unit 137 to receive information about the position of objects outside the vehicle (e.g., radar scenes). Similar information may be obtained from other sensors as well, such as lidar 138, camera(s) 139 etc. Since the platoon controller 410 is configured strictly as a listener on the vehicle's communication bus(es) and does not itself transmit information over such bus(es), it does not need to be ASIL compliant, as long as the control commands it outputs to the vehicle interface controller are verified to ASIL standards by the vehicle interface controller 460.

The vehicle interface controller 460 (also sometimes referred to as the system manager 460), which is ASIL compliant, is arranged to send commands to, and otherwise communicate with, the vehicle's engine controller (EECU), the brake controller (B ECU), and/or any other appropriate controllers either directly or via one or more communications buses, such as the vehicle's CAN bus(es).

In the illustrated embodiment, the interface 420 between platoon controller 410 and vehicle interface controller 460 (also sometimes referred to as the system manager 460) is fairly narrowly defined. It includes the substantive commands generated by the platoon controller—which in the illustrated embodiment include torque request 422, brake request 424, and optionally a retarder request 426. When the platoon controller also controls the steering or other aspects of the host vehicle steering and/or other appropriate control commands (not shown) may be included as well.

The interface 420 also includes a platooning state request indicator 428 that is a signal from the platoon controller to determine whether or not its output should be directing operation of the vehicle. The platooning state request indicator 428 may take many forms, as for example a simple flag that when high indicates that the platoon controller 410 believes that platooning is/should be active and that its torque, braking and retard commands 422, 424, 426 should be followed. In such an arrangement, a low flag state indicates that the platoon controller believes that it is not controlling the vehicle. The vehicle interface controller 460 does not forward any torque, braking, retard or other control commands at any time that the platooning state request indicator 428 indicates that platoon control is not active. In the event (generally unlikely) that one of the safety monitors 465 indicates that platooning is not appropriate when the platoon controller 410 determines that platooning is valid (as indicated by platooning state request indicator 428), the vehicle interface controller/system manager 460 initiates a termination of the platoon.

The interface 420 also facilitates the transmission of certain state information—which is preferably ASIL validated state information—about both the host vehicle and the partner truck that is useful to the safety monitors. Specifically, the host vehicle state information 441 includes state information about the host vehicle that has been validated (e.g., ASIL-C validated) by the system manager 460 and is useful to one or more safety monitors on the partner vehicle. The partner vehicle state information 444 includes state information about the partner vehicle that has been validated by the partner vehicle's system manager and is useful for one or more safety monitors 465 on the host vehicle. Host vehicle state information 441 is transmitted to the platoon controller 410, which forwards such information without modification to the gateway 470, which in turn forwards the host vehicle state information to the gateway on the partner vehicle. Partner vehicle state information 444 received by gateway 470 from the partner vehicle's gateway is forwarded without modification to the platoon controller 410 and from there to system manager 460 (again without modification). Preferably the host state information 441 is transmitted with a checksum or other suitable data integrity verification mechanism that allows the receiving system manager to verify that the data it receives is uncorrupted. Any corrupted information can then be ignored. With this approach the ASIL validated state information is passed without modification from one ASIL compliant device (system manager 460 on a first platoon partner) to another (system manager 460 on a second platoon partner) and therefore is suitable for use in ASIL compliant safety checking algorithms—even when intermediate transmitting devices (e.g., platoon controller 410, gateway 470) are not themselves ASIL compliant.

The host and partner vehicle state information may include any ASIL validated state information that is used by any of the safety monitors. This may include, for example, vehicle wheel speeds, brake requests, torque requests and/or delivered torque, brake air supply pressure, steering position, accelerometer readings, brake pad wear, tire pressure, engine temperature, pedal position and/or any other information about the partner vehicle used by the system manager 460 as part of a safety monitor. To the extent that the platoon controller 410 utilizes partner state information originated by an ASIL validated device beyond the state information used by the system manager 460, that information can optionally be included in the vehicle state information 441, 444 as well—although such inclusion is not necessary and usually not desirable since such information can typically be obtained and sent by the partner vehicle's platoon controller, which reduces the bandwidth that needs to be allocated to the interface 420.

It is noted that some of the host vehicle's sensor information (e.g., wheel speed, brake pedal position, radar scenes, etc) is used by both the platoon controller 410 and the system manager 460. Since the platoon controller 410 is preferably an authorized listener on any appropriate vehicle control bus(es), the platoon controller does not need to wait to receive such information from the system manager. Rather, it obtains any relevant host vehicle sensor information directly from the appropriate sensor over any suitable connection such as an appropriate CAN bus. However, any sensor information relevant to the system manager on the partner vehicle is read by the system manager (regardless of whether it is also read by the platoon controller) and included in host vehicle state information 441 so that the partner vehicle's system manager is ensured that such information is ASIL verified. In other embodiments any host vehicle sensor information that is not directly accessible by the platoon controller can be received via the system manager 460 acting as an intermediary.

Although there will be some overlap in the sensor information used, it should be appreciated that the host vehicle sensor information used by the host vehicle platoon controller 410 and the host vehicle system manager 460 will often vary and may further vary from the partner vehicle sensor information of interest. For example, the host platoon controller utilizes GNSS position data in the determination of the torque and braking requests, however the GNSS position information may not be utilized by the System Manager since it is not ASIL compliant.

Some of the sensor information that is used by the safety monitor on the host vehicle may not be needed by the safety monitor on the partner vehicle. This may include information such as the radar scenes, the accelerator pedal position, inputs from a host vehicle driver interface device 469, etc. To the extent that such sensor information is not used by the partner vehicle, there is no need for such information to be included in the vehicle state information 441, 444.

Some of a host vehicle's sensor information that is used by the platoon controller on the partner vehicle may not be ASIL compliant and therefore may not be used in the safety monitors on the partner vehicle. Such, sensor information that is not relevant to the safety monitors on the partner vehicle does not need to be included as part of vehicle state information 441, 444. Rather, such data may be obtained by the platoon controller 410 and sent to the corresponding platoon controller on the partner vehicle (by way of communication controllers 470). For example, it is extremely difficult to ASIL validate GPS or other GNSS position data. Therefore, GNSS position data is preferably not included in the vehicle state information 441, 444. Rather, such information is passed from the host vehicle's platoon controller to the partner vehicle's platoon controller via the gateways 470.

The driver interface device 469 may be a button or other suitable mechanism positioned at a convenient location on the host vehicle dashboard or elsewhere in the host vehicle cabin. The driver interface device 469 is a mechanism that the driver may press as appropriate to indicate that the driver is ready to platoon during initiation of a platoon, or to initiate the dissolution of a platoon when platooning is no longer desired. The use of the driver interface device 469 is described in more detail in U.S. patent application Ser. No. 15/607,902 which is incorporated herein by reference. In the illustrated embodiment, commands from the driver interface device 469 (which are preferably ASIL compliant) are sent to the vehicle interface controller 460 and passed from there to the platoon controller 410. Similarly, requests to the driver interface device pass from the platoon controller to the vehicle interface controller 460 and from the vehicle interface controller 460 to the driver interface device 469. This architecture simplifies the work that must be done to make the driver interface device 469 ASIL compliant. It should be appreciated, however, that in other embodiments, the platoon controller 410 may also be a direct listener to commands from the driver interface device. In the embodiment illustrated in FIG. 6, interface 420 includes driver platoon related requests and commands 427 which represent the request sent to and commands received from the driver interface device 469.

In some specific embodiments, the vehicle interface controller 460 is implemented as a single dedicated integrated circuit chip and the platoon controller 410 and gateway processor 470 are each implemented as separate system on modules (SOMs).

The platoon control system hardware architecture illustrated in FIG. 6 is particularly well suited for efficiently handling platooning control related tasks in an ASIL compliant manner using information available from a variety of sources including sources that are not themselves ASIL. With the described arrangement, the powertrain control commands ultimately issued by the control system may be ASIL rated.

The hardware architecture of FIG. 6 also has several advantages from a security standpoint. In the illustrated embodiment, the gateway processor 470 is not connected to any of the vehicle's control related communications buses (e.g., the CAN bus(es)). Therefore, the gateway processor 470, which is potentially the least secure of the three hardware components, is not able to transmit any information directly onto any of the more secure vehicle communications buses or receive any information directly from such buses—which is advantageous from a security standpoint since a nefarious entity cannot gain control the vehicle in any way by somehow hacking into the gateway processor 470. Furthermore, with this arrangement, the gateway processor 470 does not need to be ASIL compliant which greatly simplifies its certification.

In some embodiments, at least one of the vehicle communications buses is a dedicated sensor information bus that only carries sensor-based information. The use of sensor information buses is particularly useful for transmitting high volume information such as the information or data transmitted by radar units, lidar units, camera units, ultrasound units, GNSS units, etc. In most applications, the information transmitted over a sensor information bus will be synthesized information. For example, in the context of a radar unit, the information transmitted over the sensor information bus may be the identification of objects detected by the radar unit together with the relative position and relative velocity of such objects. Similar types of information may be received from lidar, cameras and/or other distance measuring technologies. Information transmitted from camera units and/or other sensors may also arranged to predict future movements or intentions of detected objects.

The specific information transmitted over the sensor information bus may vary widely in accordance with the needs and capabilities of any system, and when desired, the transmitted information may include, or take the form of rawer forms for sensor data. An advantage of using one or more dedicated sensor information buses is that the sensor information, which may be both relatively high volume and time critical, does not unduly clog other vehicle information buses and is not delayed by the transmission of other types of information over such buses. It also makes it easy to provide access to the sensor information to components needing such information while still controlling such components access to controllers or devices that such components don't need to have access to—which is desirable from a security standpoint.

### Safety Algorithms

In the primary embodiments described above, the safety monitors 465 are resident on the vehicle interface controller 460. Although this architecture is particularly desirable, it should be appreciated that safety monitors may be provided at other locations in the system in addition to, or in some circumstances, in place of, being located on the vehicle interface controller. For example, in some embodiments, it may be desirable for various vehicle controllers such as an ECU or a brake controller to execute its own safety monitors in addition to, or in place of safety monitors executed as part of the vehicle interface control.

An extremely wide variety of different safety algorithms can be implemented by the safety monitors and the information used by the safety algorithms may come from a wide variety of sources. In many circumstances, a safety monitor will utilize sensor information from the host vehicle and/or a connected or partner vehicle. Virtually any sensor information deemed useful to a safety check may be used. By way of example, some of the sensor information that may be used by one or more safety monitors may come from radar units, lidar units, one or more cameras, ultrasonic distance measuring units, a compass, gyroscopes, GNSS sensors, accelerometers, wheel speed sensors, tire pressure sensors, brake pad wear sensors, brake pressure sensors, engine temperature sensors, ambient temperature sensors, humidity sensors, weather sensors, pedal position sensors, engine speed sensors, engine torque sensors, transmission configuration sensors, engine speed sensors, tire wear sensors, vehicle weight sensors, suspension pressure sensors, trailer identification information, system fault sensors, occupant detection sensors, seatbelt status sensors, etc. The safety monitors may also use system faults identified by various engine or other vehicle diagnostic systems.

In many circumstances, the safety monitors fuse information received from one or more host vehicle sensors, with information (e.g. sensor information) received from other vehicles to verify the reasonableness of the commands (e.g., torque and braking commands) received from the connected vehicle/platoon controller 110. Other safety algorithms may utilize information received from driver inputs alone or in combination with sensor information received from one or both vehicles. Such driver inputs may take the form of inputs to the host (or partner vehicle) driver interface device 469, driver-initiated movement of an accelerator or brake pedal, actuation of a retarder or any other available source. Still other safety monitors can utilize information from external sources such as a network operation center or a source of traffic or road information as part of a safety check.

The ability to fuse verified information received from a second (e.g. partner vehicle) with sensor data received from the host vehicle itself and/or host vehicle driver inputs as part of the safety algorithm check is particularly powerful.

In implementations that utilize a vehicle interface controller is often desirable to execute any safety algorithms that utilized verified data received from another vehicle or other external sources on the vehicle interface controller. In this way, any safety algorithms executed on the host vehicle controller cannot be influenced by, and do not need to be aware of, anything that occurs outside of the vehicle, which inherently provides another layer of security.

### Message Logging

As mentioned above, the gateway 470 preferably includes a message logger 473 that is configured to log a variety of messages and other information passed there through in order to provide a comprehensive record of platoon session that can be useful for diagnostic, machine learning purposes and other purposes. In general, it is desirable to log all of the control related messages that pass between the vehicles through the gateway. This includes the verified partner state information 444 and the verified host vehicle state information 441 that is passed between the system managers 460 through the gateway 470. It also includes any sensor information transmitted to, from or between the platoon controllers 410, such as GNSS position data (such information is sometimes referred to herein as unverified state information since it is not ASIL verified by the system manager even though it should be appreciated that various data verification can be performed on such data by a GPS unit, the platoon controller, the gateway itself or any other suitable unit if desired).

In some embodiments the platoon controller itself does not have any logging capability—which has the advantage of simplifying the platoon controller's tasks and relieving it of the complexity and computational load associated with logging. In such embodiments it is desirable to transmit commands generated by the platoon controller such as the torque request 422, the braking request 424, retarder request 426 and platoon state request 428 to the gateway for logging purposes even if those commands are not conveyed to the partner vehicle.

When desired, other sensor information that is utilized by the platoon controller but not passed to the partner vehicle such as accelerator pedal inputs, radar scenes or scenes from other environmental sensors such as lidar, camera systems, etc. may be recorded as desired for diagnostic purposes. The specific information recorded may vary based on the design goals of the logging and/or diagnostic system. It is noted that high bandwidth streams that are not directly used in platoon control such as the partner vehicle video feed transmitted to dashboard display 475 or received from the forward-facing camera 477 would typically not be logged, although that is possible.

In many embodiments, the system manager 460 also does not have any independent logging capabilities. When that is the case, the system manager can be configured to send any information desired to be logged to the gateway 470 as well. (Such messages pass through the platoon controller 410 in the illustrated embodiments). Examples of information that may be desirable to log may include messages relating to any safety monitor algorithms that detect an unusual situation or a potential problem; the commands receive from the driver interface device, the actions of the safety monitor itself, etc.

In general, all of the messages logged are time stamped so that their order and relative timing can readily be reconstructed as desired.

In the description above, a safety focused architecture that is well suited for use in autonomous vehicle and connected vehicle is described. Although the invention has been described primarily in the context of a platoon control system, it should be appreciated that the described architecture is very well suited for use in a wide variety of connected vehicle application in which the control of a host vehicle is based in part on sensor inputs from one or more other vehicles. Thus, exactly the same architectures can be used in systems in which a connected vehicle controller that generates torque, braking and/or other control commands based in part on inputs from a second vehicle is substituted for the platoon controller.

More broadly, the described use of higher safety level processing of control commands generated by a vehicle controller by a separate system can be used in a wide variety of different autonomous and automated vehicle applications (including both partially and fully autonomous/automated vehicle control). For example, a wide variety of different autonomous/automated vehicle controllers can readily be substituted for the described platoon controller.

Voice Communications for Platooning Vehicles

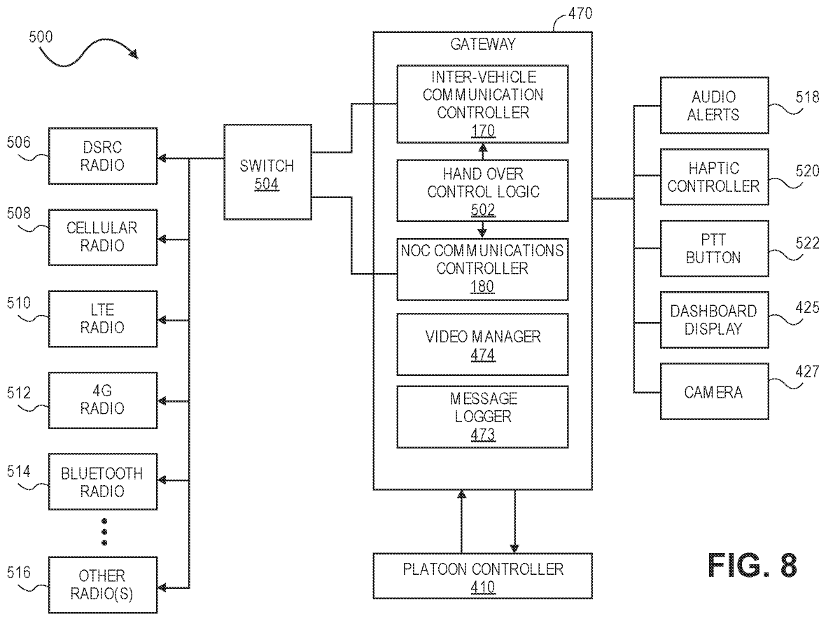

Referring to FIG. 8, a block diagram 500 of a gateway 470 and associated components for implementing voice communications for platooning vehicles in accordance with a non-exclusive embodiment of the invention is shown.

The gateway 470 includes an inter-vehicle communication controller 170, hand-over control logic 502, NOC communications controller 180, video manager 474 and message logger 473. As elements 180, 474 and 473 were previously described, a detailed explanation of each is not repeated herein.

The inter-vehicle communication controller 170, the hand over control logic 502, and NOC communication controller 180, as described in more detail below, are provided to manage voice communications between a host vehicle and (a) a partner vehicle in a platoon, (b) the NOC and (c) other non-platooning vehicles, for instance, the ability for a driver to broadcast a message to other drivers in a fleet or in a surrounding geographic area.

The gateway 470 inter-operates with one or more radios through a switch 504. In the embodiment shown, the one or more radios may include a DRSC radio 506, a cellular radio 508, a Long Term Evolution (LTE) radio 510, a 4G radio 512, a Bluetooth radio 514 and possibly additional radios, generically referred to as “other radios” 516, such as a 5G radio.

The number of radios listed may be redundant and are shown for the sake of completeness. It should understood that in actual implementations, fewer radios may be used. However, the list of radios 508-514 should also not be construed as limiting in any regard. On the contrary, any type of radio suitable for voice communications, whether known now or developed in the future, may be used. For instance, future generations of cellular (e.g., 5G, 6G or beyond) may be used.

The DSRC radio 506 provides a direct communication channel with other vehicles having a similarly equipped DSCR radio. As previously noted, the DSRC radio is used for transmitting control data used by the platoon controller 410 to manage platooning and maintain the gap between partnered vehicles. In addition, as described in more detail below, the communication link established by the DSCR radio 506 can also be used for voice communications directly between platooning vehicles. In other words, voice communications can be “piggy-backed” on top of the already existing data communication link between platooning vehicles. The DSRC link may also be used for sending/receiving video between platooning vehicles.

The various radios 508-512 (cellular, LTE, 4G), are each reliant on a wireless network infrastructure (not illustrated in FIG. 8) to facilitate voice communications between the host vehicle and other platooning vehicles, the NOC and/or other third-party vehicles not participating in a platoon with the host vehicle.

The Bluetooth radio 514 is typically used within the cabin of a vehicle. As is well known, Bluetooth enables “hands-free” voice communications using either a headset or a microphone and speakers built into the cabin of the vehicle.

The gateway 470 also operates in cooperation with other elements provided on the host vehicle for implementing voice communications, including audio alerts generator 518, a haptic controller 520, a Push-To-Talk (PTT) button 522, a dashboard display 425 and a camera 427. The audio alerts generator 518 generates various alerts, such as chimes, chirps, rings, alarms, etc. used for implementing various voice communication protocols. The haptic controller 520 is optionally used for generating sensory alerts to drivers of vehicles, such as vibrating seats, vibrating steering wheels, etc. The PTT button 522 is used for activating PTT voice transmissions.

In various embodiments, the PTT button 522 may be implemented in a number of different ways. For instance, the PTT button 522 may be a foot-activated button provided on the floor of the cabin of the host vehicle, a hand-activated button provided on the dashboard or elsewhere within reach in the cabin, a button provided on a handset (not illustrated), etc.

### Multiple Voice Links

The gateway 470 provided on a host vehicle is capable of establishing multiple redundant and possibly simultaneous voice communication links. These links enable the host vehicle to engage in voice communications between the host vehicle and (a) a partner vehicle in a platoon, (b) the NOC and (c) other non-platooning vehicles.

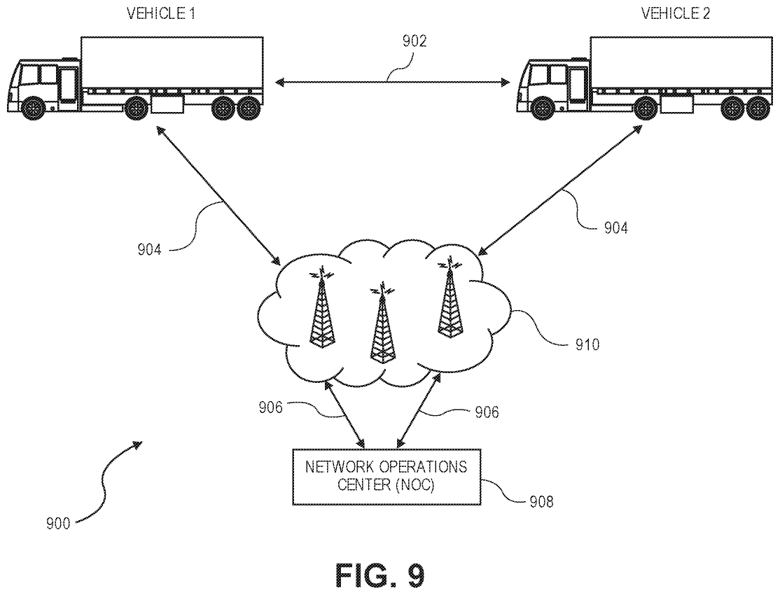

Referring to FIG. 9 a diagram 900 illustrating various redundant and possibly simultaneous links for voice communication in accordance with a non-exclusive embodiment is shown. In diagram 900, there are at least three possible voice communication links:

(1) The first is a direct link 902 established by the DSRC radios 506 on vehicle 1 and vehicle 2 operating in a platoon. The direct link 902 allows the drivers of the platooning vehicles to engage in voice communications directly between the vehicles without having to rely on a network infrastructure external to the vehicles;

(2) The second is a wireless or cellular link 904; and

(3) The third is another wireless or cellular link 906 with a NOC 908.

In the case of the latter two links 904, 906, a network infrastructure 910 including at least one node is required to establish the links. The network infrastructure 910 typically includes one or more nodes such as multiple cell towers, servers, switching centers, etc. As cellular network infrastructures are well known, a detailed description is not provided herein for the sake of brevity.

By establishing up to three simultaneous voice links, it is possible for drivers to communicate with one another either (a) directly, vehicle-to-vehicle, via link 902, (b) vehicle-to-vehicle via the cellular link 904 and (c) vehicle-to-NOC via a link 906.

In addition, the links 904 and/or 906 allow drivers of vehicles to multicast or broadcast voice transmissions to a large number of other vehicles, such as those in a fleet or those in a surrounding geographic area.

### Using Multiple Voice Links for Organizing Platoons

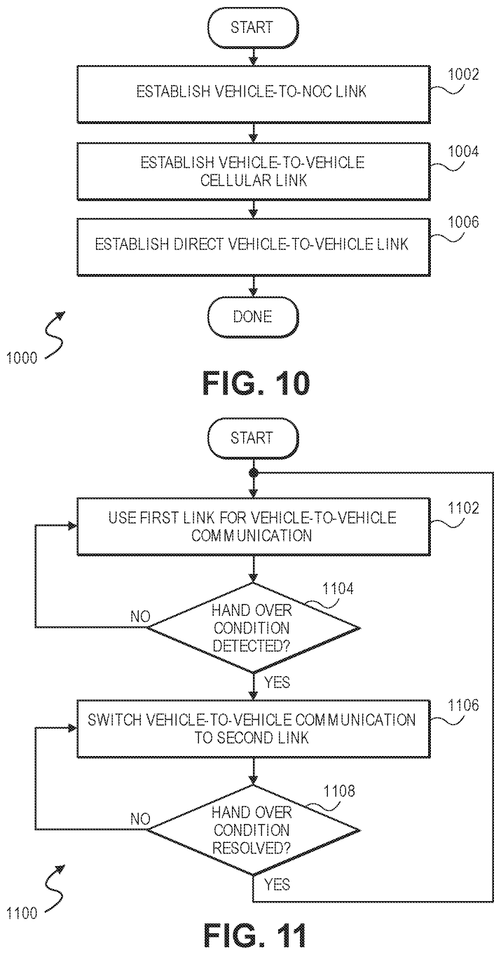

Referring FIG. 10, a flowchart 100 illustrating a sequence for establishing various voice communication links during organizing, engaging and maintaining a platoon between two (or possibly more) vehicles is illustrated. The steps described below are largely performed or managed by the inter-vehicle communication controllers 170 and NOC communication controllers 180 provided in the gateway 470 of each vehicle.

In the initial step 1002, the NOC 908 may ascertain or identify two or more vehicles suitable for platooning within a given geographic area and based on one or more criteria. Such criteria may include, but is not limited to for instance, the identification of the drivers, membership of the vehicles in a fleet, the direction of travel of the vehicles, the destination of the vehicles, route of travel of the vehicles, etc. It should be understood that this list of factors in determining or ascertaining vehicles that may be suitable for platooning is not exhaustive. These and many other factors may be used.

For instance, if there are two Fedex tractor-trailer trucks in the vicinity of the Phoenix, Ariz., and both traveling to Texas, then the NOC 908 may ascertain that these two vehicles are good candidates for platooning. Accordingly, the NOC 908 will establish links 906 with the NOC communication controller 180 of each vehicle. Once communication between the NOC 908 and the drivers of the two vehicles is established, then instructions are provided to the two drivers to meet or rendezvous at a determined location.

In the next step 1004, the drivers may establish a second cellular link 904 between the two vehicles for the purpose of facilitating the rendezvous. By establishing the cellular link 904, the drivers can communicate with one another, coordinating their meeting.

In step 1006, at the point of contact, the drivers engage in the platoon. As or soon after the platoon is established, the DSRC radios 506 on each vehicle establish the direct voice communication link, allowing the drivers to speak to one another directly, without relying on a network infrastructure 910.

It should be understood that the scenario described above is merely exemplary and should not be construed as limiting. On the contrary, it is not necessary to establish or use all three voice communication links. In general, only one needs to be used. However, it is typically easier to organize, rendezvous and engage the platoon if multiple links are used.

The vehicles in the platoon do not necessarily have to be members of the same fleet (e.g., Fedex). Alternatively, the vehicles selected for platooning can be part of different fleets or not members of a fleet at all. Also, the criteria used for selecting vehicles to pair in a platoon may widely vary. The vehicles, for instance, may be selected because they are traveling in the same general direction, but not necessarily to the same destination.

### Redundancy

One of the benefits of maintaining two or more simultaneous voice communication links between rendezvousing vehicles or platooning vehicles is redundancy. For a variety of reasons, any of the three links, 902, 904 and/or 906 may be unreliable or fail. With wireless cellular networks, dead spots or areas of little to no coverage is common. For instance, cellular coverage may become unreliable or lost with vehicles traveling through rural areas, hilly/mountainous regions, through a canyon or tunnel, etc. The direct voice link 902 established by the DSRC radios 506 may also fail or become unreliable for a number of reasons. DSRC radios 506 typically require a “line of sight” between the two vehicles. If the line of sight is broken, for example, by the vehicles navigating a sharp turn, or when the lead vehicle has crested a peak, while the following vehicle is still climbing the peak, then the link may temporarily break or become unreliable. Accordingly, with redundant links, either all or the more reliable of the multiple links may be used at any point in time.

The ability to redundantly maintain two (or more) links in parallel provides a number of advantages, including:

(1) Providing the ability to select the highest quality link;

(2) Possibly combining the voice media transmitted over two (or more) links. For instance, if both links are unreliable, the ability to merge the voice communications sent over redundant links may yield a decipherable result when otherwise the transmission over a single link alone would be undecipherable;

(3) Cost, meaning if one link is more expensive to use (e.g., cellular), then a less expensive link may be used;

(4) The ability to select one link versus another link based on other factors, such as range, network congestion, network reliability, network latency, geography (e.g., avoiding cellular dead zones), or any other relevant factor.

### Hand-Over

With redundancy, the need to switch between multiple links will often arise. A need to seamlessly “hand-over” from one link to another is therefore needed.

Referring to FIG. 11 a flowchart 1100 showing steps for a hand-over of voice communications between different links is illustrated. The steps described below are largely performed or managed by the inter-vehicle communication controllers 170 and hand-over control logic 502 provided in the gateway 470 of each vehicle.

In the initial step 1102, voice communications are conducted over a first vehicle-to-vehicle link.

In decision 1104, the first link is continuously monitored to determine if a hand-over condition occurs. If not, then voice communications continues over the first link.

In step 1106, if a hand-over condition occurs, then voice communications switches to a second redundant link.

In step 1108, the hand-over condition is continually monitored. Provided the hand-over condition persists, the second redundant link is used.

When the hand-over condition is resolved, then optionally another switch occurs back to the first link, as provided in step 1102.

For example, the first link can be link 902 and the second link is cellular link 904. If the link 902 becomes unreliable or fails, for any reason, then alternatively the second link 904 may be used, at least temporarily, until the integrity of link 902 is restored.

In other embodiments, any one of the links 902, 904 or 906 may be the first link and any of the links 902, 904 or 906 may be the second link. By providing the ability to switch voice communications between different links whenever a hand-over condition or situation is detected, the reliability of voice communications between vehicles can be significantly improved.

One approach for determining when a hand-over condition occurs is based on a percentage of acknowledgments received for transmitted voice packets. For instance, if the acknowledgments rate exceeds a predetermined threshold, then it is assumed that the link is reliable. On the other hand, if the acknowledgment rate falls below the threshold, then it is assumed that there is a reliability/quality issue with the link. If the controller 170 and logic 502 on a vehicle determines that the acknowledgment rate falls below the threshold, then it may switch from one link to another. As a result, a transition to the redundant second voice link occurs.

With voice media, in non-exclusive embodiments, the threshold may range anywhere from sixty to eighty percent. With packet losses lower than this threshold range, the voice media may become inaudible. As a result, switching to the second link may become necessary or desired. It should be understood that the provided percentage range is merely exemplary. Any threshold percentage or range, above or below that provided herein, may be used.

A number of other factors or criteria may be used in triggering a hand-over condition, such as cost of operation, voice transmission quality, availability, network latency, range, network congestion, location, geography and other factors. As a general rule, the link 902 established by the DSRC radios 506 can be operated at little to no cost, whereas cellular links 904 and 906 typically cost money. As a result, using the DSRC 902 as the first or primary link, and either links 904 or 906 as backup in hand-over situations, is typically the most cost effective solution. Again, however, maintaining the DSRC link as the primary link is by no means a requirement. Any of the links 902, 904 and/or 906 can be designated as the primary or first link and the others designated as the “hand-over” link.

Other factors worthy of consideration is latency on one link versus the other, voice quality on one link versus the other, congestion or traffic on one link versus the other, geography and location (e.g., cellular may not be reliable in certain locations or types of terrain), etc. For example, if a vehicle is approaching a cellular dead zone, then a hand-over to another link, such as the DSRC, may be desired. These are just a few factors in considering if a hand-over situation is warranted or not.

### Streaming Protocols

For any of the links 902, 904 and 906, any streaming protocol for transmitting media, including voice, can be used. Some possible alternatives that can be used may include, but is not limited to, the User Datagram Protocol (UDP), the Transmission Control Protocol (TCP), or Real-time Transport Protocol (RTP). Each of the above-listed streaming protocols has advantages and disadvantages in the context of voice communications for vehicles.

TCP has the advantage of guaranteed delivery. A next packet is not sent until an acknowledgment of receipt of the previously sent packet is received by the sender. If no acknowledgement is received, the lost packet is resent. If conditions on a link, however, are poor, waiting for acknowledgments may significantly increase latency. TCP is therefore not always advantageous with vehicle voice communications since the integrity of a given link is likely to widely vary from good to poor quality based on a wide variety of factors, such as location, geography, terrain, range, etc.

On the other hand, with UDP, packets are sent regardless if previously sent packets are received or not. If a packet is dropped or lost, no attempt is made to resend the packet. If conditions on a link are good, most if not all sent packets will be delivered, resulting in high quality voice communications. On the other hand, if conditions on the network are poor, the percentage of lost packets may be significant, meaning the link is unreliable and the transmitted voice media may be undecipherable. If conditions on the link are somewhere in between good and poor, then some packets may be dropped while others are delivered. However, voice is fairly tolerant of dropped packets, meaning a certain percentage of packets can be lost and the voice will still be decipherable. As such, UDP is often a good choice with voice communications because (1) latency is not created while waiting for acknowledgments and (2) voice will often be decipherable when conditions on the link are somewhere between ideal and poor (i.e., “good enough” for voice), which is often the case with the links 902, 904 and/or 906.

Protocol with Acknowledgments But Without Retry

In a non-exclusive embodiment, the Applicant proposes using a transmission protocol that relies on an acknowledgment of delivered packets, but does not (1) wait to receive an acknowledgement before sending new packets or (2) attempt to resend lost packets. By using such an approach, latency is reduced because there is no waiting for an acknowledgment before packets are sent and congestion on the link is reduced because there are no sending retries of lost packets. Another advantage of this approach is that with the acknowledgments, the sender can determine the quality of the link. If the percentage of lost packets is high or above a threshold, then an assumptions that the link is down or unreliable can be made. Alternatively, if the percentage of lost packets is low or below the threshold, then it can be assumed the link is operational. As a result, intelligent decisions can be made regarding to use one link versus another and/or switch or hand-over to another link. In a non-exclusive implementation, the an “acknowledgment” protocol can be layered over UDP, resulting in a combined protocol that provides acknowledgments without retrying to send lost packets.

### Local Network Topologies

With platoons involving three (3) or more vehicles, it may be advantageous to create one of several different local network topologies when using the direct link 902 among the vehicles.

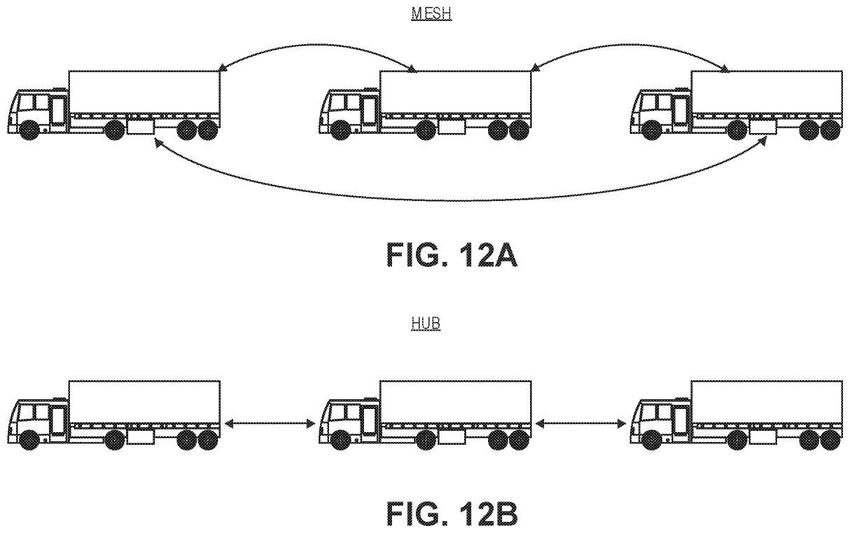

As illustrated in FIG. 12A for instance, the three vehicles may be arranged in a mesh network, with each of the three vehicles able to directly communicate with the other two.

Alternatively, as illustrated in FIG. 12B, one of the vehicles may be configured as the hub (e.g. the center vehicle). With this arrangement, any voice communications between any two non-hub vehicles is routed through the hub vehicle. Any voice communication between the hub vehicle and a non-hub vehicle is direct. In this latter embodiment, it is noted that any of the vehicles can be configured as the hub, not just the center vehicle as illustrated.

### Push-To-Talk

Push-To-Talk (PTT) is a well known voice communication protocol typically conducted over a half-duplex communication link or channel With PTT systems, only one party can transmit at a time. When a user wishes to speak, they select or push a talk button, which generates a request to access the link. If the link is busy, meaning it is controlled by another user who is transmitting over the link, then access is denied. On the other hand, if the link is not being used, then access to the link is granted and the user may begin transmitting. By following this protocol, only one speaker may control the link and transmit at a time.

Citizen Band or “CB” radios, which rely on conventional PTT, is a known form of voice communication among certain drivers, such as truck drivers. Conventional CB radios using PTT has its disadvantages when used in the context of platooning. First, since PTT relies on a broadcast model, a sender has no idea if an intended recipient has received or listened to the transmission. Second, there are numerous situations with platooning when one driver may desire to interrupt the other driver while transmitting. With conventional PTT however, no interrupts are permitted.

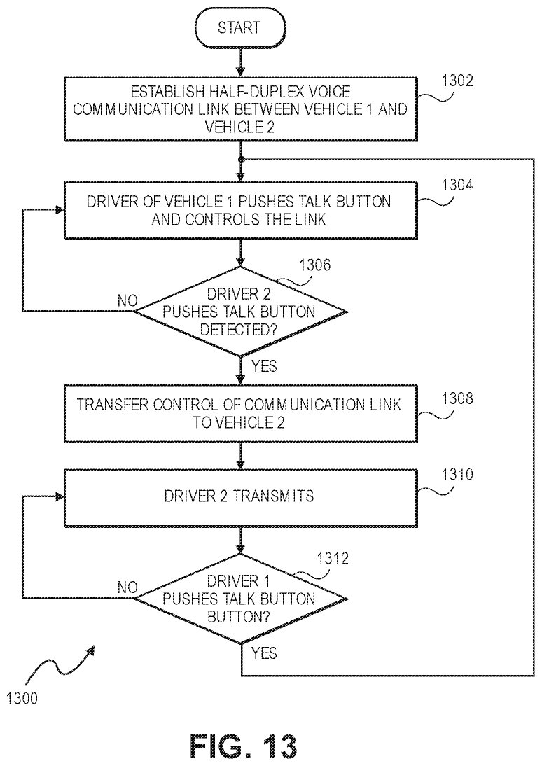

Referring to FIGS. 13-15 several flow diagrams illustrating various PTT protocols for platooning vehicles in accordance with the present invention are shown. The steps described below are largely performed or managed by the inter-vehicle communication controllers 170 provided in the gateway 470 of each vehicle and in communication with one another.

Referring to FIG. 13, a flow diagram 1300 illustrating steps for implementing a PTT protocol with interrupt is illustrated.

In the initial step 1302, a half-duplex voice communication link is established between vehicle 1 and vehicle 2. In various alternative embodiments, the half-duplex communication link may be any of links 902, 904 or 906.

In step 1304, the 1st driver of vehicle 1 pushes his/her PTT button 522 and begins transmitting over the link.

In decision 1306, the control button 522 of the 2nd driver of the second vehicle is continuously monitored while the 1st driver is transmitting.

If the 2nd driver does not push his/her PTT button 522, driver 1 may continue transmitting without interruption.

As provided in step 1308, if the PTT button 522 is pushed by the 2nd driver, then the transmission of the 1st driver is interrupted. By cooperation of the inter-vehicle controllers 170 on each vehicle, control of the link is transferred to driver 2.

In step 1310, driver 2 transmits voice over the link.

In decision 1312, the PTT button 522 of the first driver is monitored. If pushed while driver 2 is transmitting, then control of the links returns to the first driver, who may then begin a new transmission, as provided in step 1304.

The above interrupt PTT protocol is advantageous in the context of platooning vehicles for a number of reasons. First, if one of the drivers needs to speak, he/she can interrupt the transmission of the other driver. Second, the ability to interrupt allows the drivers of a platoon to engage in a conversation somewhat similar to a full-duplex conversation, where each driver can speak when he/she wishes, possibly interrupting the other driver. However, unlike a full-duplex conversation, the underlying link remains a half-duplex. As a result, there is never a “live” microphone in the cabin of two vehicles, eliminating the possibility of unwanted noise and/or an echo created by a feedback loop.

The Applicant has also found that providing a notification for interrupts when control of the PTT link is transferred from one driver to the other is advantageous. In other words, whenever an interrupt occurs, one or both drivers are notified.

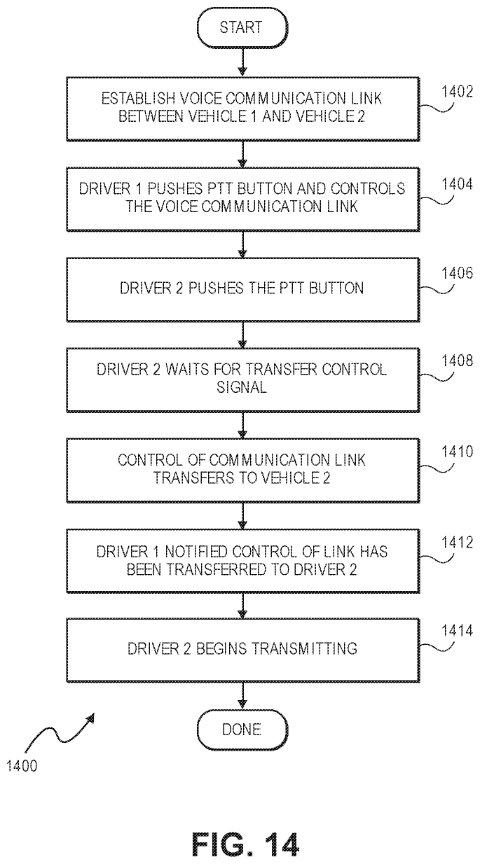

Referring to FIG. 14, a flow chart 1400 for notifying drivers of PTT interrupts is illustrated. The steps described below are also largely performed or implemented by the inter-vehicle communication controllers 170 provided in the gateway 470 of each vehicle.

In the initial step 1402, a half-duplex voice communication link is established between vehicle 1 and vehicle 2. In various alternative embodiments, the link can one (or possible more than one) of the links 902, 904 and/or 906.

In step 1404, a first driver in vehicle 1 selects his/her PTT button 522, gaining control of the link. The first driver thereafter begins transmitting.

In step 1406, a second driver in vehicle 2 pushes his/her PTT button 522 while the first driver is transmitting.

In step 1408, the second driver waits for a transfer control notice signifying that control of the link has been transferred from the first driver to the second driver (as described above with regard to FIG. 13). The transfer control notice may be implemented in a wide variety of different ways, such as an audio alert (e.g., a chime or chirp), a visual alert (e.g., lighting of an LED or other feature on the dashboard of vehicle 2), feedback generated by haptic controller 520 (e.g., vibrating the driver's seat or the steering wheel), or any combination thereof.

In step 1410, control of the link is transferred from the first driver to the second driver after the notice.

In step 1412, the first driver is notified that control of the link has been transferred to the second driver. The notification can be audible, visual, or sensory, similar to described above with regard to step 1408.

In step 1414, the second driver may begin transmitting over the link.

The ability to notify when a transfer of the control of the voice link is beneficial because each party is aware who is in control of the link. Without this awareness, it is possible for the two drivers to be “transmitting” at the same time—meaning both are speaking at the same time, but only one is actually transmitting over the link.

In the context of platooning vehicles, it is also advantageous to notify a driver that his/her transmission (1) has been received by the other driver and (2) to notify both drivers in the event the link goes down.

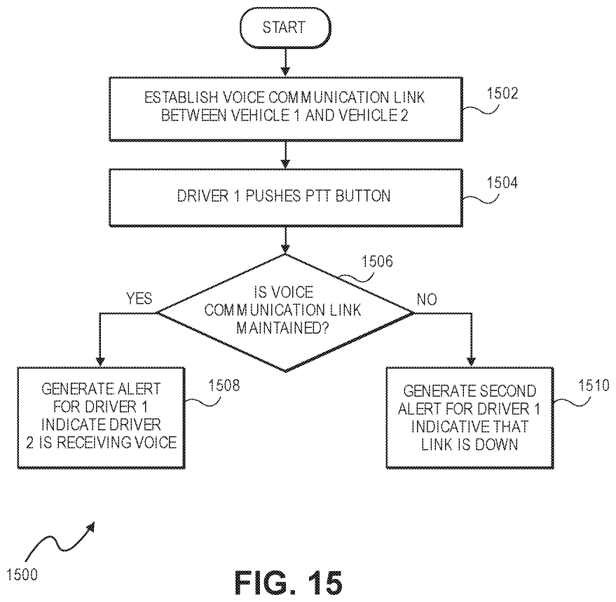

Referring to FIG. 15, a flow diagram 1500 for notifying drivers in a platoon when transmissions are received and/or if the voice communication link goes down is illustrated. The steps described below are also largely performed or implemented by the inter-vehicle communication controllers 170 provided in the gateway 470 of each vehicle.

In step 1502, a voice communication link is established between vehicle 1 and vehicle 2 operating in a platoon. Again, the link may be any of links 902, 904 or 906, or any combination thereof.

In step 1504, a first driver in vehicle 1 pushes his/her PTT button 522.

In step 1506, the inter-vehicle communication controller 170 monitors the link to determine if it is operational or not. As previously discussed, the percentage of lost packets can be compared to a threshold. If less than the threshold, then controller 170 makes a determination that the integrity of the link is sound. On the other hand if the percentage of lost packets is greater than the threshold, then the controller 170 determines that the link is down and/or is unreliable.

In step 1508, a “positive” alert is generated and provided to the first driver if the link is maintained. Such a positive alert may be pleasing sound, such as a chime. With the integrity of the link maintained, an assumption is made that the transmission is being delivered to the second driver.

In step 1510, the controller 170 generates a “negative” notice informing the first driver that the link is down if such a determination is made. A negative notice may be an alarming sound, such as a buzzer or an alarm.

Although the features and functions described with respect to FIGS. 13-15 are separately described, it should be understood that this is by no means a requirement. To the contrary, each was described individually for the sake of clarity. In actually embodiments, the features and functions described with respect to FIGS. 13-15 would typically simultaneously be implemented in PTT embodiments of the present invention. As such, drivers in a platoon would be notified when interrupts occur, when control of the link is transferred from one driver to the other, when transmissions are delivered, and when they are not. Furthermore, the above flow charts 13-15 were described in the context of a pair of platooning vehicles for the sake of simplicity. It should be understood that the same features and functions can also be used when a platoon involves more than two vehicles.

Managing Interrupts from the NOC

On occasion, vehicles receive incoming communications from the NOC 908. If vehicle-to-vehicle voice communications are ongoing when the NOC 908 wishes to contact either or both vehicles, an interrupt protocol is beneficial.

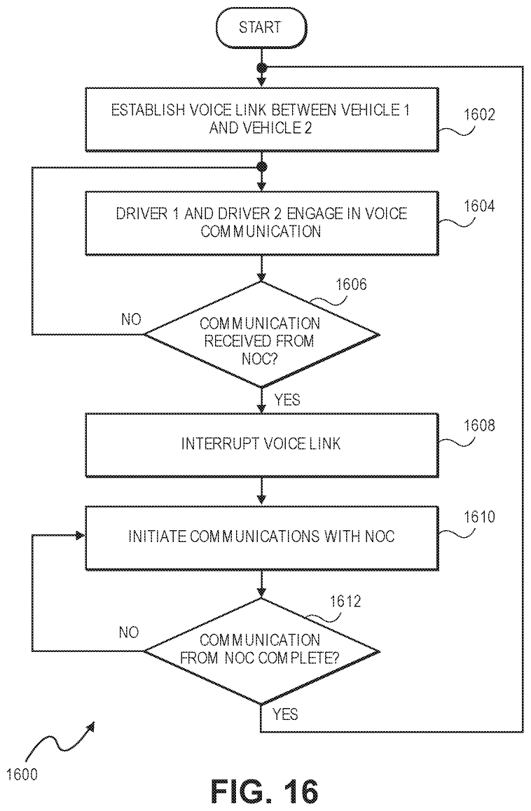

Referring to FIG. 16, a flow diagram 1600 illustrating steps implemented by the inter-vehicle communication controller 170 and the NOC communication controller 180 provided in the gateway 470 of each vehicle is illustrated.

In the initial step 1602, the vehicle 1 and vehicle 2 establish a vehicle-to-vehicle voice communication link. Again, the link can be either of links 902 or 904 discussed above.

In step 1604, the drivers of the two vehicles exchange voice communications.

In decision step 1606, the NOC communication controller 180 on each vehicle monitors for incoming communication from the NOC 908. If no such communication is detected, then the drivers may continue their voice communications per step 1604.

In step 1608, the vehicle-to-vehicle link is interrupted by the controller 170 on a vehicle if an incoming communication from the NOC 908 is detected by the NOC communication controller 180. As a result, the drivers are unable to communicate directly with one another at least temporarily.

In step 1610, the communications between the interrupted vehicle and the NOC 908 is initiated. In different scenarios, the communication can be one-directional (e.g., from the NOC to the vehicle(s)) or bi-directional. Alternatively, the communications from the NOC 908 can be directed to an individual vehicle, platooning vehicles, or multi-casted or broadcast to a large number of vehicles. In situations where the NOC 908 wishes to communicate with multiple vehicles, each vehicle involved in vehicle-to-vehicle communication will ordinarily undergo the same or similar interrupt procedure as described herein.

In step 1612, the NOC communication controllers 180 determines when communication with the NOC 908 has ended. A time-out procedure may be used. If no further communications with the NOC 908 occur after a predetermined time of time has elapsed, then controllers 170/180 can make the assumption that communication with the NOC 908 is complete. Alternatively, the NOC can generate a signal signifying the end of communications. Once a communication session with the NOC 908 is done, the drivers can resume their voice communication per step 1604.

### Automatic Establishment of a Voice Link in Response a Trigger Event

On occasion, it may be beneficial to automatically initiate voice communications between drivers of vehicles in a platoon. For example, if a trigger event occurs, it may make sense to automatically establish a voice communication link between the vehicles, allowing the drivers to speak to one another.

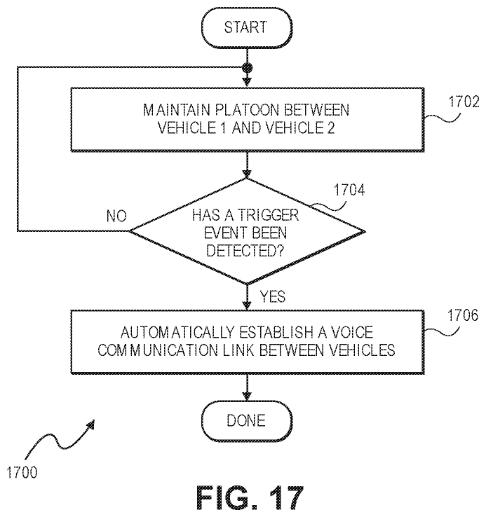

Referring to FIG. 17, a flow diagram 1700 for automatically establishing a voice communication link in response to a trigger event is illustrated. In general, the steps described below are implemented by the inter-vehicle communication controller 170 on a vehicle.

In the initial step 1702, a platoon is maintained between a pair (or more) of vehicles (e.g., vehicle 1 and vehicle 2). However, for whatever reason, the drivers are not speaking to one another.

In decision step 1704, the controller 170 monitors for a trigger event. For instance, a trigger event may include the detection of a dissolve the platoon condition, a warning condition, a hazardous road condition, a braking event, a steering event, an acceleration event, etc. These are just a few possible trigger events. In actual implementations, any event or circumstance can be defined as a trigger event.

In the event a trigger event is detected, then a voice communication link is automatically established between the vehicles in step 1706, allowing the drivers to communicate. In various embodiments, the link can be any one or a combination of the links 902, 904 and/or 906 as described above.

By way of example, consider a situation where a driver in a lead vehicle suddenly brakes hard to avoid an obstacle on the road. In this situation, the front driver may want to verbally inform the driver of the following vehicle of the situation. By automatically establishing the link (assuming a link was not previously established), the drivers may communicate almost immediately without delay.

### Automatic Interrupt of a Voice Link in Response a Trigger Event

Alternatively, on other occasions, it may be beneficial to automatically interrupt voice communications between drivers of vehicles in a platoon in the event of a trigger event occurs.

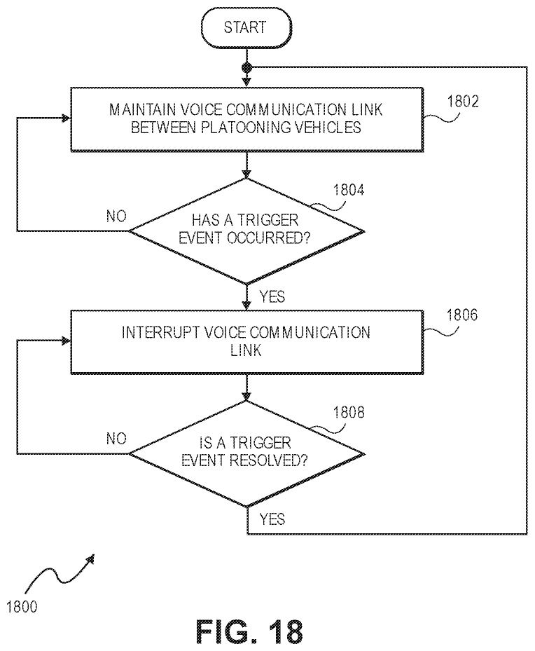

Referring to FIG. 18, a flow diagram 1800 for interrupting a voice communication link in response to a trigger event is illustrated. In general, the steps described below are monitored and implemented by the inter-vehicle communication controllers 170 on the platooning vehicles.

In the initial step 1802, a voice communication link is maintained between a pair (or more) of platooning vehicles (e.g., vehicle 1 and vehicle 2).

In decision step 1804, the controller(s) 170 on one or both vehicles monitors for a trigger event that may require an interrupt in voice communications. For instance, a driver of a third vehicle may wish to join the platoon. Or other events or conditions may occur that warrant the interruption of voice communications, such as an emergency vehicle (e.g., ambulance, police car, fire truck) attempting to communicate, another set of platooning vehicles attempting to communicate, a vehicle attempting to cut into a the middle of the platoon, etc.

In the event a trigger event is detected, then in step 1806, the voice communication link is interrupted.

In decision 1808, the controller(s) 170 monitor to determine if the trigger event is resolved. If not, the voice communication link remains interrupted. If yes, then the link is restored and the drivers can resume voice communications per step 1802.

### Notices and Alerts

Within the context of voice communications for platooning vehicles notices and alerts can be used for a wide variety of reasons. In general, these notices can be organized into “positive” and “negative” categories.

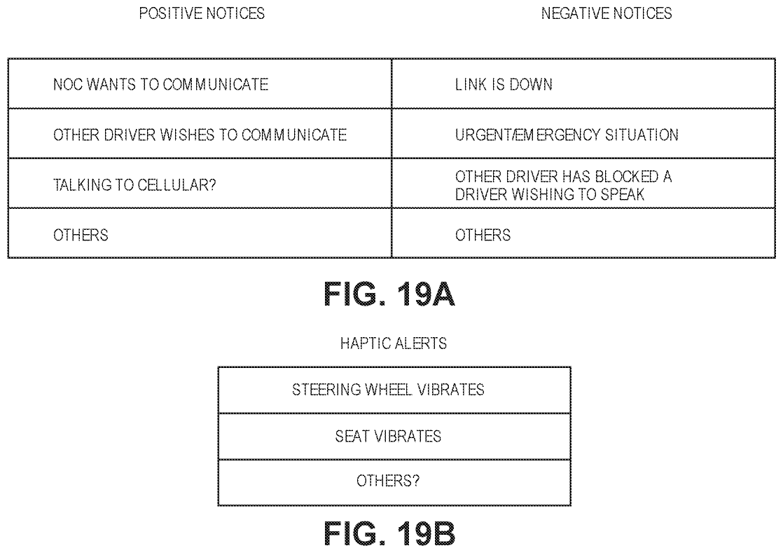

As illustrated in FIG. 19A, a table listing both positive and negative notices is provided. Positive notices may be generated for such activities such as (a) the NOC wishes to communicate with the platooning vehicles, (b) one driver wishes to communicate with the other driver, Negative notices may be generated for such conditions as when a voice communication link goes down, in the event of an emergency situation, one driver had blocked the other from speaking.

FIG. 19B is a table of possible haptic alerts. Such haptic alerts include vibrating a driver's seat or the steering wheel of a vehicle, the vibration of a smart device such as a phone or watch, etc.

### Miscellaneous Embodiments

As vehicles separate and dissolve a platoon, the direct link 902 is also dissolved. In order to maintain communications, there is a seamless transition to cellular link 904. As a result, the two (or more) vehicles can continue voice communications even after the platoon is dissolved.

In some embodiments, efforts are made to maintain the connection 906 between vehicles and the NOC 908 continuously. With an open link, the NOC 908 can transmit to the vehicle, and vice-versa, without delays in setting up or tearing down communication links. With such embodiments, the link 906 may temporarily go down from time to time for a variety of reasons, such as geography, the terrain the vehicle is traveling, network traffic, etc. When whatever the condition causing the disruption is resolved, the link is typically automatically restored.

The links 902, 904 and 906, to the extent network conditions permit, can all be maintained in parallel. By maintaining redundant links, voice communications can be maintained in a wide variety of scenarios, including in situations when one or possibly even two links go down. In addition, with multiple links, drivers may select the one they wish to use.

In yet other embodiments, a PTT button 522 does not necessarily have to be used by a driver to initiate voice communications. Voice activated commands can also be used to open a communication link and the engage in conversations with drivers of other vehicles as well as with the NOC 908.

As will be apparent to those familiar with the art, the described control functionality implemented by the gateway 470, controllers 170 and 180, the hand-over control logic 502, etc., can each be implemented algorithmically using software or firmware algorithms executing on one or more processors, using programmable logic, using digital or analog components or using any combination of the preceding.

In the detailed description above, it is assumed that the platooning vehicles are tractor-trailers. However, under no circumstances are voice communications as described herein limited to tractor-trailer trucks. On the contrary, voice communications as described herein may be used in any vehicle, including passenger vehicles, gas or diesel-powered vehicles, hybrid vehicles, electric vehicles, motorcycles, etc. Therefore, the present embodiments should be considered illustrative and not restrictive and the invention is not to be limited to the details given herein, but may be modified within the scope and equivalents of the appended claims.

1. A voice communication system for platooning vehicles, comprising:
a first communication gateway provided on a first vehicle;
a second communication gateway provided on a second vehicle,
the first communication gateway and the second communication gateway arranged to transfer data over a first communication link between the first and the second vehicles, the transferred data used by the first and second vehicles to maintain a platoon between the first the second vehicles; and
a voice communication system, integrated into the first communication gateway and the second communication gateway, enabling drivers of the first vehicle and the second vehicle to exchange voice communications with one another while the first and the second vehicles are platooning.

2. The voice communication system of claim 1, wherein the exchanged voice communications are transmitted over the same first communication link used to transfer the data used to maintain the platoon.

3. The voice communication system of claim 1, wherein the first communication link includes a data channel for the transmission of the data used for maintaining the platoon and a second channel for the transmission of the exchanged voice communications.

4. The voice communication system of claim 1, wherein voice packets containing voice media of the exchanged voice communications are interspersed over the first communication link with data packets containing the data used to maintain the platoon.

5. The voice communication system of claim 1, wherein the exchanged voice communications are encrypted.

6. The voice communication system of claim 1, wherein the voice communication system is a Push-to-Talk (PTT) voice communication system.

7. The voice communication system of claim 6, wherein the PTT voice communication system is a half-duplex system that enables a bi-directional exchange of the voice communications between the two vehicles, but prevents simultaneous bi-directional exchange of the voice communications.

8. The voice communication system of claim 6, wherein the PTT voice communication system includes an interrupt feature that enables a first driver to interrupt and transmit voice media in lieu of a second driver transmitting voice media.

9. The voice communication system of claim 1, wherein the first and the second vehicles are both tractor-trailer trucks.

10. The voice communication system of claim 1, further comprising an interrupt feature that interrupts the exchange of the voice communications if a predetermined condition is detected by either vehicle.

11. The voice communication system of claim 10, wherein the predetermined condition comprises one of the following:
a dissolve platoon condition;
a warning condition;
a hazardous condition;
a braking condition;
a steering condition; or
an acceleration condition;

12. The voice communication system of claim 1, wherein the first communication link is a direct connection between the first vehicle and the second vehicle.

13. The voice communication system of claim 12, wherein the first communication gateway and the second communication gateway are further arranged to establish a second communication link between the first and the second vehicles over a network.

14. The voice communication system of claim 13, wherein the first communication gateway and the second communication gateway are further arranged to simultaneously maintain the first and the second communication links between the first and the second vehicles.

15. The voice communication system of claim 13, wherein the first communication gateway or the second communication gateway are further arranged to switch voice communications from the first communication link to the second communication link when a trigger event occurs.

16. The voice communication system of claim 15, wherein the trigger event includes one of the following:
(a) the first communication link goes down;
(b) the first communication link is unreliable;
(c) packet loss over the first communication link exceeds a predetermined threshold;
(d) either the first vehicle or the second vehicle wishes to broadcast a voice communication to a third party not in the platoon with the first and second vehicles;
(e) the first vehicle or the second vehicles receive a transmission from a Network Operations Center (NOC);
(f) the first vehicle or the second vehicles receive an interrupt from the NOC;
(g) a third vehicle is attempting to rendezvous and join the platoon; and
(h) per instructions from a driver of either the first vehicle or the second vehicle.

17. The voice communication system of claim 14, further arranged to perform at least one of the following:
select either the first or the second communication links depending on which is of higher quality;
combine voice media transmitted over the first or the second communication links;
switch to the second data link if the first data link goes down;
switch to the first data link if the second data link goes down;
use the less expensive to use or operate among either the first or the second data links.

18. The voice communication system of claim 14, wherein the wherein the first communication gateway and the second communication gateway are further arranged to provide either driver of the first vehicle or the second vehicle an option to elect to transmit voice communications over either the first of the second communication links.

19. The voice communication system of claim 1, wherein the first communication gateway and the second communication gateway are further arranged to:
transmit packets containing voice media between the first vehicle and the second vehicle;
ascertain a percentage of lost packets between the first vehicle and the second vehicle; and
switch from using the first communication link to a second communication link if the ascertained percentage of lost packets exceeds a threshold.

20. The voice communication system of claim 1, wherein the first communication link uses a transmission protocol that acknowledges receipt of packets without attempting to resend lost packets.

21. The voice communication system of claim 1, wherein the first communication link uses one of the following transmission protocols:
(a) User Datagram Protocol (UDP)
(b) Transmission Control Protocol (TCP);
(c) Real-time Transport Protocol (RTP); or
(d) a streaming protocol.

22. The voice communication system of claim 1, wherein the first communication gateway and the second communication gateway are further arranged to:
transmit voice communications between the first vehicle and the second vehicle using the first communication link;
ascertain a trigger condition; and
switch from using the first communication link to a second communications link when the trigger condition is ascertained.

23. The voice communication system of claim 22, wherein the trigger condition is based on one or more of the following:
cost of operation;
voice transmission quality;
availability;
latency
range;
network congestion;
location; and
geography.

24. The voice communication system of claim 1, wherein the first communication gateway and the second communication gateway are further arranged to each establish a wireless communication link with a remote Network Operations Center (NOC) via a wireless network infrastructure.

25. The voice communication system of claim 24, wherein the wireless network infrastructure comprises one or more of:
(a) a Wifi network;
(b) a Long Term Evolution (LTE) network;
(c) a 4th generation broadband cellular network (4G);
(d) a 5th generation broadband cellular network (5G);
(e) a cellular network.

26. The voice communication system of claim 13, wherein the network includes at least one node, not located on either the first vehicle or the second vehicle, for the routing of the exchanged voice communications between the two vehicles.

27. The voice communication system of claim 13, wherein the network is one of the following:
(a) a cellular network;
(b) Internet;
(c) a satellite network;
(d) a WiFi network;
(e) a local area network; or
(f) any combination of (a) through (e).
